(19) United States
(12) Patent Application Publication
(10) Pub. No.: US 2025/0125362 A1
(43) Pub. Date: Apr. 17, 2025

(54) Conducting Polymer-Based Electrode Matrices for Lithium-Ion Batteries

(71) Applicant: University of Manitoba, Winnipeg (CA)

(72) Inventors: Christian Kuss, Winnipeg (CA); Van At Nguyen, Winnipeg (CA)

(21) Appl. No.: 18/293,536

(22) PCT Filed: Aug. 9, 2022
(86) PCT No.: PCT/CA2022/051216

§ 371 Date: Jan. 30, 2024

Related U.S. Application Data
(60) Provisional application No. 63/238,917, filed on Aug. 31, 2021.

(51) Int. Cl. H01M 4/62; C08L 1/28; C08L 65/00; H01M 10/0525

(52) U.S. Cl. CPC H01M 4/622; C08L 1/286; C08L 65/00; C08L 2203/20; H01M 10/0525

(57) ABSTRACT

Polypyrrole:carboxymethyl cellulose (PPy:CMC) composites were synthesized by in situ chemical oxidative polymerization. Following that, carbon-additive-free LiCoO2/PPy:CMC cathodes were fabricated by using water as a processing solvent. Carbon-additive-free cathodes were then cycled to study the performance of PPy:CMC electrode matrices. The results indicate that PPy:CMC composites were electrochemically stable within the cathode operating voltage window. As the cycle number increased, electrolyte anions became dopants for PPy units in PPy:CMC composites. The sharp spike in cell voltage of LiCoO2/PPy:CMC cathodes in the first charging cycle indicated that undoped/neutral PPy units in PPy:CMC composite were oxidized and doped to become fully conductive. This unique phenomena teaches an activation procedure for using other CP-based electrode matrices in Li-ion batteries such as polyaniline:carboxy methyl cellulose (PANI:CMC) composites.

### PRIOR APPLICATION INFORMATION

The instant application claims the benefit of U.S. Provisional Patent Application Ser. No. 63/238,917, filed Aug. 31, 2021 and entitled “CONDUCTING POLYMER-BASED ELECTRODE MATRICES FOR LITHIUM-ION BATTERIES”, the entire contents of which are incorporated herein by reference for all purposes.

### BACKGROUND OF THE INVENTION

The electrode matrix is usually comprised of carbonaceous conductive additives and non-conducting polymeric binders. Over the last two decades, the most commonly used electrode matrix is polyvinylidene fluoride/carbon black (PVDF/C) due to its excellent electrochemical/chemical stability and ease of processing[1]. In the development of new high-energy-density battery materials, some intrinsic drawbacks of PVDF/C are becoming more prominent[2-4]. Firstly, processing of battery electrodes with PVDF/C requires toxic N-Methyl-2-pyrrolidone (NMP) and electrode drying and solvent recovery are energy intensive[5]. Secondly, fluoropolymers, such as PVDF, exhibit famously weak intermolecular interactions with other substances, which makes them well suited as lubricants[6]. Simultaneously, they are very weak adhesives in electrodes, which significantly contributes to battery performance degradation due to electrode disintegration upon cycling[2,4,7]. Strong interaction between the electrode matrix and active materials is vital to suppress electrode cracking, maintain electrode architecture as well as enhance electrode stability[8]. Thirdly, carbonaceous additives exhibit little polarity at their surface. Given highly polar oxide intercalation materials and electrolytes, this lack of polar interactions within the matrix increases the occurrence of contact loss and carbon agglomeration[4,9]. The development of conductive electrode matrices with polar surfaces improves ease, cost, and environmental impact of electrode processing, and addresses longevity of electrodes with large volume changes by increasing adhesion of the conductor to the active materials[2,4,10].

Several strategies have been reported to prepare alternative electrode matrices to enhance battery performance. Most studies have focused on using aqueous battery binders and other carbonaceous additives[10-12]. Moving to aqueous binders, such as carboxymethyl cellulose (CMC)[12,13], alginate[8,14], and polyacrylic acid (PAA)[15-17], electrode processing becomes cheaper and more environmentally friendly[5,10,13]. At the same time, it exploits intermolecular interactions and chemical bonding with active materials[8,18,19], resulting in stronger adhesion. As a result, the electrode integrity and good performance in high-energy-density electrodes, such as silicon, can be maintained over more cycles. An alternative approach exploits the combination of electrical conductivity, mechanical flexibility, and extended microstructure of conducting polymers to boost the electrical conductivity of battery electrodes with promising results[20-25]. By adding a small amount of conducting polymer into a mixture of active materials, conventional binders, and carbon additives, the conducting polymers can bridge connections between conductive particles that would otherwise be lost, leading to the maintenance of a continuous conductive network. Other electrode matrix designs are based on functional group-modified conducting polymers[26-28] and three-dimensional conducting polymer gels[29-33], in which carbon additives and/or additional binders (PVDF, CMC) are involved during electrode fabrication.

Some studies have reported the fabrication of carbon-additive-free electrodes with only active materials and poly(3,4-ethylenedioxythiophene):polystyrene sulfonate (PEDOT:PSS)[9.34]. No additional conductive additives and binders are required to fabricate electrodes, which suggest the possibility of using conducting polymers as single-component multifunctional electrode matrices. Despite their promising results, however, the high cost of PEDOT:PSS hinders the wide-scale application as a battery electrode matrix. The success of PEDOT:PSS is based on the combination of the conducting polymer PEDOT with a water-dispersible polymer PSS. As PEDOT carries positive charges (electronic holes) along its backbone in its conductive state and PSS contains negatively charged sulfonate groups, both polymers are permanently intertwined, forming a molecular composite[35]. In this composite, PEDOT provides electronic conductivity, whereas PSS increases adhesion, gives the composite film-forming properties and makes it dispersible in water. Inspired by the PEDOT:PSS structure, other combinations of conducting polymers and polyelectrolytes can be developed, as demonstrated herein.

### SUMMARY OF THE INVENTION

This work introduces a design concept for a new class of electrode matrices for Li-ion batteries. By polymerizing conducting polymer (CP) monomers in the aqueous solutions of polyanionic binders, molecular composites are formed and could be used as multifunctional electrode matrices for Li-ion battery electrodes. Conducting polymer monomers are the smallest constructive units of conducting polymers, which contain conjugated backbone. Common conducting polymer monomers are aniline, pyrrole, 3,4-ethylenedioxythiophene, and the like. Polyanionic binders are polymeric compounds containing negatively charged groups such as carboxylate and sulfonate. Examples for polyanionic binders are carboxymethyl cellulose (CMC), polyacrylic acid (PAA), poly styrene sulfonate, and the like. One of the examples for multifunctional CP-based battery electrode matrices is PPy:CMC composite. As a conductor, PPy:CMC composite provides electrical conduction pathways between electrode active materials, allowing batteries to function at high C-rates without carbon additives added. As an adhesive binder, PPy:CMC composite was found to have strong interactions with LiCoO₂ (LCO) and LiNi_{1/3}Mn_{1/3}Co_{1/3}O₂ (NMC111) cathode active materials.

Strong interactions are also expected between PPy:CMC composites and other electrode materials such as silicon/tin-based materials (Li-ion battery anodes), and sulfur (Li—S battery cathodes), to name a few. Such unique features could be beneficial for the development of other rechargeable batteries including Li-ion batteries, Li—S batteries and multivalent metal-ions batteries. Aqueous electrode processing was also achieved by using this class of electrode matrices, thus contributing to the development of a greener battery fabrication process.

According to an aspect of the invention, there is provided an electrode matrix comprising: an electrically conductive polymer; and a polyanionic binder.

According to another aspect of the invention, there is provided a method of activating an electrode matrix comprising: mixing an electrically conductive polymer, a polyanionic binder and an oxidant; fabricating an electrode matrix from the mixture of the electrically conductive polymer, the polyanionic binder and the oxidant; and subjecting the electrode matrix to a charging voltage at or above a typical upper cut off voltage for the electrode matrix until at least an expected electrode capacity is reached.

### BRIEF DESCRIPTION OF THE DRAWINGS

FIG. 1. Simplified reaction scheme of the in situ polymerization of PPy:CMC composites. The targeted molecular structure of PPy:CMC composites (right) shows ionic bonding between PPy and CMC, in which carboxylate groups serve as main immobilized dopants for PPy. Generally, positively charged PPy could be doped by X⁻ (carboxylate, chloride and hydroxide anions). Negatively charged carboxylate groups could be balanced by Y⁺ (PPy, iron, and hydrogen/hydronium cations).

FIG. 2. SEM and TEM images of in situ polymerized PPy:CMC 1:1 R.2.5 composite (a,c,e) and mechanically mixed PPy:CMC 1:1 R.2.5 composite (b,d,f). PPy:CMC 1:1 R.2.5 composite scanning transmission x-ray microscopy. Image overlay (g): optical density in the carbon K-edge region increases with brightness and contribution of the peak at 285 eV to overall optical density increases with color saturation. Average spectra in two regions of interest (h) within a region of high color saturation (red framed) and low color saturation (green framed) showing differences in the C1s→π* transition intensity.

FIG. 3. Survey XPS spectra (a) showing the complexity of the PPy:CMC 1:1 R.2.5 composite structure. High-resolution XPS scans for N 1s (b), C 1s (c), and O 1s (d).

FIG. 4. (a) Trend in electrical conductivity of PPy:CMC composites. (b) Normal Load needed to cause initial detachment and full delamination of LiCoO₂/PVDF/C and LiCoO₂/(PPy:CMC 1:1 R.2.5) electrodes from Al current collector.

FIG. 5. Bruggeman model for the electrical conductivity of PPy:CMC R2.5 composites.

FIG. 6. Dispersion stability of PPy and PPy:CMC 1:1 R2.5 composite in water with a concentration of 4 mg/ml.

FIG. 7. Digital images of LiCoO₂/(PPy:CMC 1:1 R2.5) electrode with H₂O as solvent (a) and LiCoO₂/PVDF/C electrode with NMP as solvent (b).

FIG. 8. The appearances of LiCoO₂-based electrodes with different PPy:CMC R2.5 composites (a,b) and PVDF/C ratio (c,d). These electrodes were subjected to pristine condition (left), and half-folding (right).

FIG. 9. Normal Load needed to cause initial detachment and full delamination of LiCoO₂/PVDF/C (a,b) and LiCoO₂/(PPy:CMC 1:1 R2.5) (c,d) electrodes from Al current collector.

FIG. 10. SEM images of LiCoO₂/(PPy:CMC 1:1 R2.50) (90:10 wt %) electrode (a,b) and LiCoO₂/PVDF/C (90:5:5 wt %) electrode (c,d).

FIG. 11. Digital and SEM images of LiCoO₂/(PPy:CMC 1:0.25 R2.50) electrode (set a), LiCoO₂/(PPy:CMC 1:0.5 R2.50) electrode (set b), LiCoO₂/(PPy:CMC 1:0.75 R2.50) electrode (set c), LiCoO₂/(PPy:CMC 1:1 R2.50) electrode (set d) and LiCoO₂/(PPy:CMC 1:1.25 R2.50) electrode (set e).

FIG. 12. Voltage Profiles of LiCoO₂/PVDF/C cathode at 0.1 C (a), LiCoO₂/(PPy:CMC 1:1 R2.75) cathode at 0.1 C (b) and at 1 C (c).

FIG. 13. Electrical conductivity of PPy:CMC 1:1 composites synthesized at different Py:FeCl₃ ratio of 1:2.5 (R2.5), 1:2.75 (R2.75) and 1:3.0 (R3.0).

FIG. 14. Galvanostatic charge and discharge voltage profiles at 0.1 C of LiCoO₂/(PPy:CMC 1:0.5 R2.50) electrode (a), LiCoO₂/(PPy:CMC 1:0.75 R2.50) electrode (b), LiCoO₂/(PPy:CMC 1:1 R2.50) electrode (c), LiCoO₂/(PPy:CMC 1:1.25 R2.50) electrode (d).

FIG. 15. Comparison between the electrical conductivity of mechanically mixed and in situ polymerized PPy:CMC composites.

FIG. 16. (a) XRD diffractogram; (b) SEM image; (c) TEM image; (d) EDX analysis result of lab-synthesized LiNi_{1/3}Mn_{1/3}Co_{1/3}O₀₂ (NMC111).

FIG. 17. (a) HRTEM image of NMC111; (b,c,d,e) elemental mapping images of NMC111.

FIG. 18. SEM images of NMC111/PPy:CMC cathode (a); and NMC111/PVDF/C cathode (b).

FIG. 19. (a) Voltage profiles, and (b) plot of charge/discharge capacity and coulombic efficiency versus cycle numbers of NMC111/PVDF/C reference cathode at 0.1 C (27.5 mA·g⁻¹).

FIG. 20. (a) Voltage profiles, and (b) plot of charge/discharge capacity and coulombic efficiency versus cycle numbers of NMC111/PPy:CMC cathode at 0.1 C (27.5 mA·g⁻¹).

FIG. 21. (a) Voltage profiles, and (b) plot of charge/discharge capacity and coulombic efficiency versus cycle numbers of NMC111/PPy:CMC cathode at 1 C (275 mA·g⁻¹).

FIG. 22. Morphologies of NMC111/PPy:CMC cathode after galvanostatic charge/discharge cycling for 100 cycles at 1 C (275 mA·g⁻¹).

FIG. 23. Voltage profiles and coulombic efficiency versus cycle number plots of LiCoO₂/PPy:CMC cathode (a,b) and LiCoO₂/PVDF/C reference cathode (c,d) cycled at 0.1 C.

FIG. 24. The XRD diffractogram of pristine LiCoO₂/PPy:CMC powder.

FIG. 25. Cyclic voltammograms of pelletized PPy:CMC composite (a) between 2.8-4.2 V vs Li/Li⁺ at different scanning rates; (b) between 0-5 V vs Li/Li⁺ at 1 mV·s⁻¹ for 5 cycles.

FIG. 26. Differential capacity (dQ/dV) analysis of LiCoO₂/PPy:CMC cathode (a,b); LiCoO₂/PVDF/C reference cathode (c,d).

FIG. 27. Nyquist plot of the as-prepared coin cell assembled with LiCoO₂/PPy:CMC cathode during the first failed charge/discharge and EIS measurement.

FIG. 28. Nyquist plots of coin cells assembled with LiCoO₂/PPy:CMC cathode (a,b); and LiCoO₂/PVDF/C reference cathode (c,d).

FIG. 29. EIS equivalent circuit for half-cell Li-ion batteries at fully charged state (a), and fully discharged state (b).

FIG. 30. XPS survey spectra of LiCoO₂/PPy:CMC cathode after galvanostatic charge/discharge cycling for 1 cycle, 10 cycles, and 100 cycles at 0.1 C.

FIG. 31. Evolution of Cl 2p XPS spectrum after cycling LiCoO₂/PPy:CMC cathode.

FIG. 32. Co 2p XPS spectra of LiCoO₂/PPy:CMC cathode after cycling for (a) 1 cycle, and (b) 100 cycles.

FIG. 33. Evolution of elemental XPS spectra after cycling LiCoO₂/PPy:CMC cathode for 1 cycles, 10 cycles and 100 cycles. (a) O 1s; (b) N 1s; (c) C 1s; (d) Cl 2p.

FIG. 34. SEM images of LiCoO₂/PPy:CMC electrodes (a) Pristine; (b) after 10 charge/discharge cycles; (c) after 100 charge/discharge cycles.

FIG. 35. Voltage profiles of (a) LiCoO₂/PVDF/C reference cathode, (b) LiCoO₂/PPy:CMC cathode, (c) LiCoO₂/PPy:CMC-centrifuged cathode with 1M LiPF₆ in DMC:EC (50:50 v:v) electrolyte. (d) Voltage profiles of LiCoO₂/PPy:CMC-centrifuged cathode with 1 M LiClO₄ in polyethylene carbonate (PC) electrolyte

FIG. 36. Voltage Profile of LiCoO₂/PANI:CMC cathode cycled at 0.1 C.

### DESCRIPTION OF THE PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned hereunder are incorporated herein by reference.

Polypyrrole:carboxymethyl cellulose (PPy:CMC) composites were synthesized by in situ chemical oxidative polymerization. Several characterization techniques were used to understand the morphology, structure, and physical/chemical properties of PPy:CMC composites. Following that, carbon-additive-free LiCoO₂/PPy:CMC cathodes were fabricated by using water as a processing solvent. Carbon-additive-free cathodes were then cycled to study the performance of PPy:CMC electrode matrices.

Furthermore, to facilitate the adoption of CP-based electrode matrices in Li-ion batteries, their compatibilities with commercially relevant LiNiₓMn_{y}Co_{1-x-y}O₂ (NMC) cathode materials were investigated. Herein, LiNi_{0.33}Mn_{0.33}Co_{0.33}O₂ (NMC111) was synthesized by the sol-gel method. Following that, for the first time, carbon-additive-free NMC cathodes were made available by using PPy:CMC electrode matrices. Regardless of eliminating carbon conductive additives from electrode composition, the NMC111/PPy:CMC cathode is able to operate at high C-rate, confirming the capability of PPy:CMC composites to provide enough electrical conductivity for battery electrodes.

As will be known by those of skill in the art, prior art LiCoO₂/PPy:CMC cathodes suffer from capacity fading. It is important to investigate the degradation mechanisms to understand the compatibility of PPy:CMC composites in Li-ion batteries, which could also proliferate the use of other CP-based battery electrode matrices. The causes of capacity fading were investigated by means of electrochemical and post-mortem chemical analyses. The result indicate that PPy:CMC composites were electrochemically stable within the cathode operating voltage window. As the cycle number increased, electrolyte anions became dopants for PPy units in PPy:CMC composites. The sharp spike in cell voltage of LiCoO₂/PPy:CMC cathodes in the first charging cycle indicated that undoped/neutral PPy units in PPy:CMC composite were oxidized and doped to become fully conductive. This unique phenomena teaches an activation procedure for using other CP-based electrode matrices in Li-ion batteries such as polyaniline:carboxymethyl cellulose (PANI:CMC) composites, as discussed herein.

According to an aspect of the invention, there is provided an electrode matrix comprising: an electrically conductive polymer; and a polyanionic binder.

The designed electrode matrices can be used for all types of cathode active materials such as for example but by no means limited to lithium transition metal oxides LiMO₂ (M are transition metals such as Co, Ni, Mn:LiMnO₂, LiNiO₂, LiNiₓMn₁₋ₓO₂, LiNiO₂, LiNiₓMn_{y}Co_{1-x-y}O₂, LiNiₓCo_{y}Al_{1-x-y}O₂, . . . ), Li-rich xLi₂MnO₃·(1−x)LiMO₂ (M are transition metals). Based on our stability measurements, the electrode matrix will also work at the anode with graphite. We believe that the electrode matrix can be used beyond intercalation materials as well, for example with alloying materials (tin, silicon, aluminum) and conversion materials (sulfur, oxygen).

In some embodiments, the electronically conductive polymer is selected from the group consisting of: polyacetylene, polyphenylene sulphide, polyphenylene vinylene, polyisothianaphthene, polythiophene, poly(3-alkylthiophene), poly(3,4-ethylenedioxythiophene), polyaniline and polypyrrole.

In some embodiments, the electronically conductive polymer is selected from the group consisting of: polythiophene, poly(3-alkylthiophene), poly(3,4-ethylenedioxythiophene), polyaniline and polypyrrole.

In some embodiments, the electronically conductive polymer is polyaniline or polypyrrole.

In some embodiments, the polyanionic binder is selected from the group consisting of: polystyrene sulfonate, sodium carboxymethyl cellulose, sodium polyacrylate, and sodium alginate.

In some embodiments, the polyanionic binder is selected from the group consisting of: sodium carboxymethyl cellulose, sodium polyacrylate, and sodium alginate.

In some embodiments, the electrically conductive polymer and the polyanionic binder are present at 30-70% electrically conductive polymer and 30-70% polyanionic binder.

In some embodiments, the electrically conductive polymer and the polyanionic binder are present at 5-95% electrically conductive polymer and 5-95% polyanionic binder.

In some embodiments, the electrically conductive polymer and the polyanionic binder are present at 40-60% electrically conductive polymer and 40-60% polyanionic binder.

As will be known by those of skill in the art, the design concept of electrode matrices from an in situ combination of electrically conductive polymer and polyanionic binder is new. No other studies claimed to make electrode matrices from the above-mentioned components. Instead, they add the two components solely as electrode additives in their composite forms. This work introduces a way to form a molecular composite, where the electrically conductive polymer is synthesized in the presence (=in situ) of the polyanion, as discussed herein. PEDOT:PSS composite is the closest relative the PPy:CMC composite, which is the representative of the new electrode matrices introduced. While PEDOT is well-known conductive polymer, PSS has not been used as polyanionic binder for battery electrodes.

This work is inspired by PEDOT:PSS structure, but the design concept is driven by the use of cheap conductive polymer monomers and relevant carboxylate-containing polyanionic binders such as carboxymethyl cellulose.

Specifically, previous studies did not synthesize molecular composites by polymerizing conducting polymer monomers in the solution of a polyanionic binder. Instead, those studies mixed pre-formed conducting polymers and polyanionic binders. As a result, no doping of conducting polymer by polyanionic binders form at a molecular level.

According to another aspect of the invention, there is provided a method of activating an electrode matrix comprising:
mixing an electrically conductive polymer, a polyanionic binder and an oxidant;
fabricating an electrode matrix from the mixture of the electrically conductive polymer, the polyanionic binder and the oxidant; and
subjecting the electrode matrix to a charging voltage at or above a typical upper cut off voltage for the electrode matrix until at least an expected electrode capacity is reached.

Specifically, in the example provided herein, the battery is prepared as usual. During the first charging cycle, the charging is cut off at the typical potential of around 4.2V only after a minimum amount of charged has passed. The battery voltage will initially rise and pass an activation voltage that is typically around 4.5V. This high-voltage step will normally last from a few seconds to 10 minutes. This activation could also be achieved by holding the charging voltage at approximately 4.5V for about 10 minutes or any other suitable method for applying a high potential to battery cells for short periods of time.

As will be appreciated by one of skill in the art and as discussed herein, surprisingly, by forming molecular composites as described herein and then following with the appropriate activation step(s) as discussed herein, the composites become sufficiently conductive that electrode formulations without carbon additives can be used.

As discussed herein, some conducting polymer units are not sufficiently oxidized and doped during synthesis as the oxidation is limited by the rate of oxidation and the oxidizing potential of the oxidant used. However, as discussed herein, the activation increases the oxidation potential beyond that of oxidant.

While not wishing to be bound to a particular theory or hypothesis, adding pre-formed conducting polymers to the mix might not work because of the low dispersibility of most conducting polymers. Specifically, increasing the content of conducting polymers in the conducting polymer composite composition would improve the electrical conductivity of conducting polymer composite; however, this will also reduce the water dispersibility and adhesion of the electrode matrix. Increasing the amount of polyanionic binders, on the other hand, improves adhesion and water-dispersibility, but decreases the amount of charge-storing materials, which in turn lowers energy per volume and mass of the electrode.

For example, as discussed herein, in one embodiment of the invention, the in-situ chemically oxidative polymerization is performed in an ice-bath to slow down the growth of the polymer chain, allowing polyanionic binder to dope along the backbone of conducting polymers and increasing PPy chain length/conductivity.

As known by those of skill in the art, carbon additives are electrically conductive. Without the presence of carbon additives in battery electrodes, the electrical connection within battery electrodes relies on the conductivity of the conducting polymer composites. Conducting polymers need to be activated to provide sufficient electrical conductivity for the battery to operate. With carbon additives present, the activation would work differently—for example, the potential may not rise at the beginning of the charging process to the high potential, but rather may rise at the very end. However, with carbon additives present, it is not clear whether an activation would be necessary at all, since carbon would likely provide sufficient conductivity.

Furthermore, adding carbon additives and conventional binders to the carbon-additive-free electrodes composed of conducting polymer composites and active materials would not make any significant difference. Specifically, while it was believed that carbon additives must be used to make operational battery electrodes, this study confirms that conducting polymer composites could provide sufficient electrical conductivity for a battery electrode.

Accordingly, in some embodiments of the invention, there is the proviso that the mixture consists essentially of an electrically conductive polymer, a polyanionic binder and an oxidant.

In some embodiments of the invention, there is provided the proviso that the mixture and the electrode matrix are substantially free of carbon additives or are free of carbon additives.

In some embodiments of the invention, the charging voltage is above the typical cut off voltage for at least a first 10% of charging.

In some embodiments of the invention, the electrode matrix is subjected to the charging voltage above the typical cut off voltage and then subjected to a standard first charge cycle.

In some embodiments of the invention, the charging voltage is held at the upper cut off voltage at the end of a first charge until theoretical electrode capacity is reached.

In some embodiments of the invention, the electrode matrix is subjected first to a minimum amount of charge at the typical upper cut off voltage and then subjected to a charging voltage above the typical cut off voltage for the electrode matrix until theoretical electrode capacity is reached.

As will be appreciated by one of skill in the art, versions and/or variations of the above-described activation protocol can be applied to any conducting polymer composites that are used in battery electrodes. By using the activation protocol, conducting polymers in conducting polymer composites could be oxidized and then doped by available anions in battery electrolyte. However, in electrode matrixes without a conducting polymer in the electrode, this activation protocol would not have the beneficial effect and may in fact cause some degradation of the electrode or electrolyte.

In some embodiments of the invention, the electronically conductive polymer is selected from the group consisting of: polyacetylene, polyphenylene sulphide, polyphenylene vinylene, polyisothianaphthene, polythiophene, poly(3-alkylthiophene), poly(3,4-ethylenedioxythiophene), polyaniline and polypyrrole.

In some embodiments of the invention, the electronically conductive polymer is selected from the group consisting of: polythiophene, poly(3-alkylthiophene), poly(3,4-ethylenedioxythiophene), polyaniline and polypyrrole.

In some embodiments of the invention, the electronically conductive polymer is polyaniline or polypyrrole.

In some embodiments of the invention, the polyanionic binder is selected from the group consisting of: polystyrene sulfonate, sodium carboxymethyl cellulose, sodium polyacrylate, and sodium alginate.

In some embodiments of the invention, the polyanionic binder is selected from the group consisting of: sodium carboxymethyl cellulose, sodium polyacrylate, and sodium alginate.

In some embodiments of the invention, the electrically conductive polymer and the polyanionic binder are mixed at 5-95% electrically conductive polymer and 5-95% polyanionic binder.

In some embodiments of the invention, the electrically conductive polymer and the polyanionic binder are mixed at 30-70% electrically conductive polymer and 30-70% polyanionic binder.

In some embodiments of the invention, the electrically conductive polymer and the polyanionic binder are mixed at 40-60% electrically conductive polymer and 40-60% polyanionic binder.

In some embodiments of the invention, the oxidant is selected from the group consisting of: chromic acid, perchloride acid, hydrogen peroxide, dibenzoyl peroxide, ammonium perchlorate, ferric chloride and ammonium persulfate.

In some embodiments of the invention, the oxidant is selected from the group consisting of: ammonium perchlorate, ferric chloride and ammonium persulfate.

In some embodiments of the invention, the oxidant is ferric chloride or ammonium persulfate.

The invention will now be further described and/or elucidated by way of examples; however, the invention is not necessarily limited to or by the examples.

### Example 1—Conducting Polymer Composites as Water-Dispersible Electrode Matrices for Li-Ion Batteries: Synthesis and Characterization

### Synthesis and Characterization

### Chemicals

For the synthesis of polypyrrole:carboxymethyl cellulose (PPy:CMC) composites, pyrrole (Sigma-Aldrich, 98%), FeCl₃ (Fisher, 98%), sodium carboxymethyl cellulose (Na-CMC) (Sigma-Aldrich, MW=250000 g/mol, degree of substitution 0.9), and ethanol (Fisher, 98%) were used as purchased without further purification. For electrode fabrication, LiCoO₂ (Sigma-Aldrich, 99.8%), PVDF (Sigma-Aldrich, 99%, MW=534 000 g/mol), C-black (Cabot, black pearls 2000), and N-Methyl-2-pyrrolidone solvent (NMP) (Sigma-Aldrich, 99%) were used. Reverse osmosis (RO) water was used throughout the experiment.

### Synthesis of PPy:CMC Composites

PPy:CMC composites were synthesized via in situ polymerization. Firstly, Na-CMC was completely dissolved in water. After that, 400 μl (˜5.8 mmol) pyrrole was added to the viscous Na-CMC solution. The mixed precursor solution was then placed in an ice bath. The mass ratio between pyrrole and CMC was varied as follow: 1:0 (0 wt % CMC), 1:0.25 (˜25 wt % CMC), 1:0.5 (˜33.33 wt % CMC), 1:0.75 (˜42.85 wt % CMC), 1:1 (˜50 wt % CMC), and 1:1.25 (˜55.5 wt % CMC), which were denoted as PPy, PPy:CMC 1:0.25, PPy:CMC 1:0.5, PPy:CMC 1:0.75, PPy:CMC 1:1 and PPy:CMC 1:1.25, respectively. FeCl₃ was dissolved in water and added dropwise into the above precursor solution. The molar ratio between pyrrole and FeCl₃ was initially fixed at 1:2.5 (denoted as R2.5) and then increased to 1:2.75 and 1:3.0, which were denoted as R2.75 and R3.0, respectively. The concentration of pyrrole was 0.6 mol L⁻¹. The polymerization reaction was carried out for 4 hours in an ice bath. The product suspensions were immersed in ethanol overnight with the suspension/ethanol volume ratio of 1:4 to induce the precipitation of PPy:CMC composites. The precipitates were filtered by vacuum filtration and washed with ethanol until a colorless filtrate was observed. The products were then dried at 80° C. under vacuum for two days.

### Material Characterization

To characterize the structure of conducting polymer composites, transmission electron microscopy coupled with energy-dispersive X-ray spectroscopy (TEM/EDX), scanning electron microscopy (SEM), X-ray photoelectron spectroscopy (XPS) and scanning transmission X-ray microscopy (STXM) were used. PPy:CMC samples were dispersed in isopropanol and drop coated on carbon-film-coated copper grids for TEM and EDX measurements on the FEI Talos F200X microscope at an accelerating voltage of 80 keV. SEM imaging was performed on an FEI Nova NanoSEM 450 microscope. SEM imaging for electrodes was performed by imaging 2×2 mm electrode pieces coated on Al substrate. XPS measurements were performed on a Kratos Axis Ultra spectrometer at a pass energy of 160 eV for survey scans and 20 eV for N 1s, C 1s, O 1s narrow scans. Charge neutralization of 2.5 eV was applied for each measurement. STXM imaging on PPy:CMC 1:1 composite was performed at the 10ID-1 SM beamline of the Canadian Light Source (CLS).

To measure the electrical conductivity of PPy:CMC composites, samples were compressed into PPy:CMC pellets and measured employing the four-point probe method on a Miller Design FPP-5000 instrument. The 0.6 mm-thick pellets were prepared by grinding 100 mg of PPy:CMC sample and compressing it at 200 MPa in a hydraulic press. In order to evaluate electrode cohesion and adhesion, scratch testing was performed on 15 mm diameter electrode pieces, which contained 20-25 μm-thick electrode coatings on a 25 μm-thick Al substrate. Scratch tests were performed with assistance from Anton-Paar on an Anton Paar MST³ Micro Scratch Tester with feed-back loop. A Rockwell diamond tip with a tip radius of 20 μm was scanned across an immobilized electrode piece at a constant speed of 3 mm min⁻¹ and a loading rate of about 45 N min⁻¹. Two failure events were recorded. An initial detachment was marked at the smallest force at which a first penetration to the Al sublayer is observed, and full delamination was marked by the continuous delamination of the electrode film from the Al substrate.

### Battery Fabrication and Testing

LiCoO₂/PPy:CMC electrode slurries were prepared by ball-milling LiCoO₂ and PPy:CMC composites in water with a solid content of ˜30 wt %. The mass ratio between LiCoO₂ and PPy:CMC composites was fixed at 90:10 (wt %:wt %). The electrode slurries were cast on 25 μm thick aluminum (Al) foil (Goodfellow, USA) using a doctor blade. The electrode thickness and mass loading were approximately 25 μm and 3 mg cm-2 respectively. After drying in a vacuum oven for two days at 80° C., electrode sheets were cut into 15 mm disks. Standard LiCoO₂/PVDF/C electrodes were prepared by a similar procedure in NMP with 5 wt % PVDF and 5 wt % carbon black unless otherwise specified. In order to evaluate electrode performance, half cells of R2032-format (MTI, USA) were assembled in an argon-filled glove box with oxygen and moisture level below 0.1 ppm. LiCoO₂/PPy:CMC or LiCoO₂/PVDF/C electrodes were used as cathodes. LiPF₆ in DMC/EC (50:50 v/v. Sigma-Aldrich) was used as the electrolyte. 15 mm lithium anode disks were cut from a lithium ribbon (Alfar Aesar, 99.9%, 0.75 mm thick). Whatman™ glass fiber (Fisher) was used as the separator. Coin cells were galvanostatically cycled with cut-off voltages of 2.8 V and 4.2 V vs. Li/Li⁺ on Neware Battery Cyclers. A current density of 274 mA g⁻¹ and 27.4 mA g⁻¹ was applied to cycle coin cells as denoted as 1 C and 0.1 C-rate, respectively.

### Results and Discussion

### Structure of PPy:CMC Composites

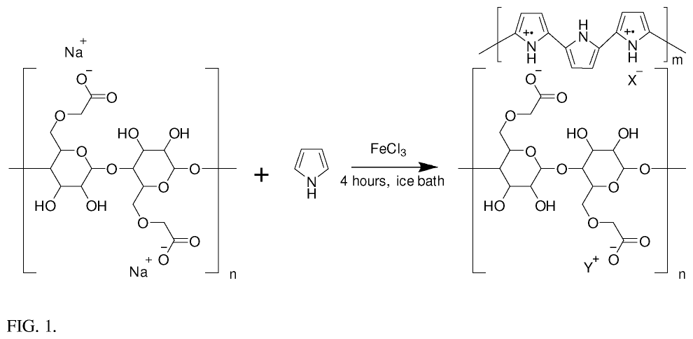

To confirm the successful synthesis of PPy:CMC composites, the chemical structure and nanoscopic morphology of the prepared composites were investigated. PPy:CMC composites were synthesized in their oxidized state by chemical oxidative polymerization of pyrrole in aqueous CMC solution. In the oxidized state, an anionic dopant is necessary to charge-balance positive charges on PPy. In the synthesis solution, those negative charges are mainly carried by carboxylate groups on CMC, which encourages the formation of a molecular composite between PPy and CMC, as presented in FIG. 1. In such composite, the large-size CMC-based anionic dopant is immobilized, leading to a homogenous distribution of properties of both components. Since ferric chloride was used as an oxidant during the polymerization process, trace amounts of iron and chloride ions are expected to be found in the final composition. Together with protons and hydroxide ions, they serve as additional charge balancers in the structure of PPy:CMC composites. The electrical conductivity of the composites is anticipated to depend on the oxidation state and doping level of PPy[36,37], as well as the structural arrangement of PPy:CMC composites[38]. The presence of CMC in the composite structure is not only responsible for the water-dispersibility of PPy:CMC composites, but it also influences electrode adhesion and cohesion. Moreover, since CMC is a non-conductive polymer, the CMC content might affect the electrical conductivity of PPy:CMC composites.

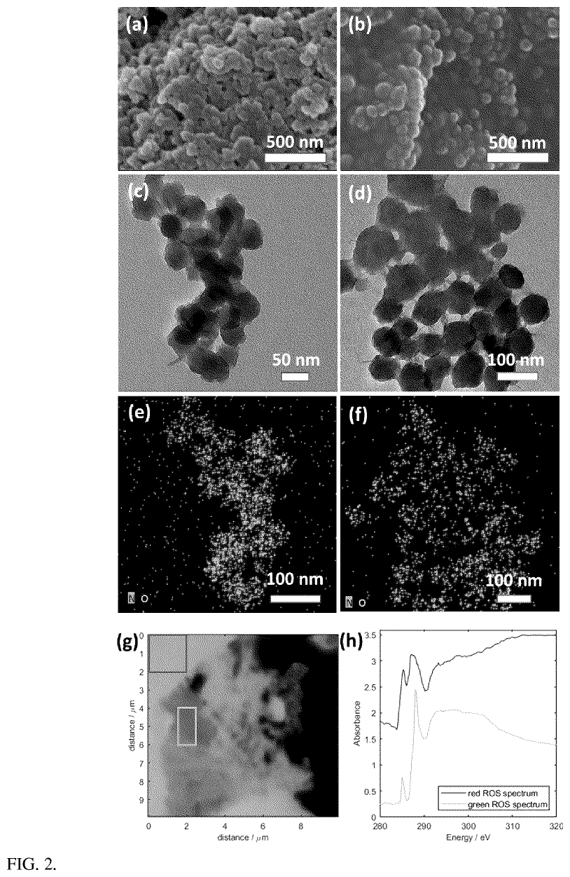

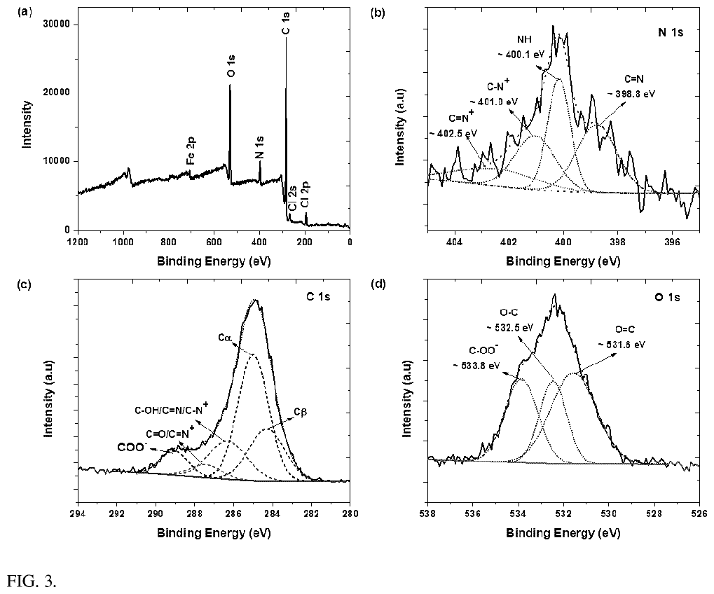

A comparison between in situ polymerized and mechanically mixed PPy:CMC 1:1 R.2.5 composites morphology was carried out. In contrast to the in situ polymerized sample, PPy in the mechanically mixed composite is already oxidized and doped when it is mixed with CMC. Consequently, such a composite would exhibit a different microstructure and potentially separate phases. FIG. 2 (a) shows the SEM image of in situ polymerized PPy:CMC 1:1 R.2.5 composite (denoted only as PPy:CMC 1:1 R.2.5), confirming a single homogenous morphology, consisting of fused nanospheres of approximately 50 nm in diameter. In contrast, the morphology of the mechanically mixed PPy:CMC 1:1 R.2.5 composite (FIG. 3.2 (b)) shows connecting material between nanospheres.

TEM reveals a nano-morphology of 50.3±2.1 nm spheres in the PPy:CMC 1:1 R.2.5. FIG. 2 (e) depicts the homogeneous distribution of nitrogen and oxygen in the elemental map of PPy:CMC 1:1 composite. Using nitrogen and oxygen signals as indicators for PPy and CMC, respectively, the elemental mapping shows a homogenous distribution of both components within the resolution limit. In comparison, the mechanically mixed PPy:CMC 1:1 R.2.5 composite exhibits more discrete spherical PPy particles with a larger particle size of 72.6±11.8 nm (FIG. 2 (f)). No significant difference in elemental distribution is observed.

To verify the chemical structure of PPy:CMC 1:1 composites, X-ray absorption and photoelectron measurements were taken. The spatially-resolved STXM image reveals a complex structural arrangement of components in PPy:CMC 1:1 R.2.5 composite (FIG. 2 (g)). The C K-edge spectrum shows two main peaks, of which the first peak at 285 eV is characteristic of the C 1s→π* transition of carbon-carbon double bonds[39]. As such, this peak is indicative of the presence of PPy and it would not be expected in pure CMC[40]. While the intensity of this peak varies with location (FIG. 2 (h)), it contributes to significant absorption intensity throughout the sample. Transitions at 288 eV and above correspond to C 1s→π* transitions of carbon-oxygen double bonds, as observed in CMC, and less specific C 1s→σ* transitions[39,40]. These spectra are consistent with the co-location of PPy and CMC in the sample with some variation in relative composition[41].

Similar structural complexity is observed in XPS measurements (FIG. 3). Given the high surface sensitivity of XPS spectra, a strong spatial dependence of the nitrogen and oxygen signals is observed that suggests surfaces that are largely CMC dominated. The survey scan exposed also a ferric chloride contamination with an Fe elemental contribution well below 1%. High-resolution spectra were recorded for C 1s, N 1s and O 1s. FIG. 3 (b) demonstrates an N 1s spectrum that is dominated by the characteristic absorption of amine/imine groups at 400.1 eV. The high binding energy shoulder corresponds to two positively charged groups C═N⁺ and C—N⁺, whereas, the low binding energy shoulder corresponds to the C═N group[42]. Peak fitting allows the extraction of PPy oxidation of approximately one charge per three pyrrole units. The C 1s XPS spectra show characteristic peaks at ˜284.3, 285.0, 286.3, 287.5, and 289.1 eV, which corresponds to PPy Ca, PPy CB, C—OH/C—N/C—N⁺, C—O/C═N⁺ and COO⁻, showing absorptions that are characteristic to PPy[43] and CMC[43]. Indications of the CMC presence are also observed in the O 1s XPS spectra with characteristic peaks for the carboxylate (COO⁻) anion. A summation of all charged groups from XPS fitting does not balance all negative charges, suggesting a role of polypyrrole protonation as positive charge carriers in the composite. While the in situ synthesis of PPy in the presence of CMC provides an improved environment to achieve doping of PPy with carboxylate groups from CMC, it is likely that competition with Cl-anions lead to mixed doping.

Together, chemical and microstructural analysis of the composites demonstrate that PPy and CMC are co-located and well distributed at the nanoscale. The obtained degree of oxidation of PPy is sufficient for significant electron conduction[44]. While these methods are not able to determine whether CMC acts as a dopant in PPy, the observations confirm the successful synthesis of a composite of PPy and CMC with homogenous distribution at the nanoscale.

### Electrical Conductivity and Water-Dispersibility

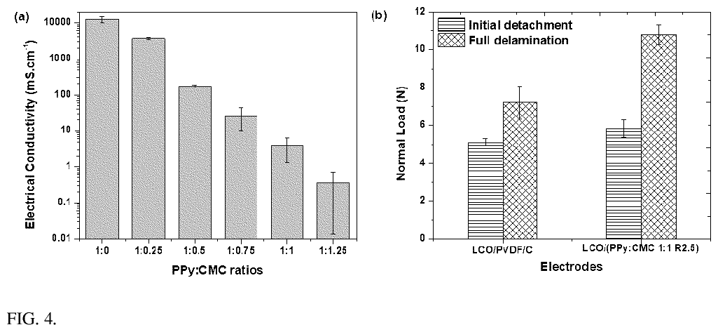

To act as the sole electrode matrix, PPy:CMC composites must have sufficient electrical conductivity to support electron conduction during charging and discharging. In order to achieve a balanced electrode charging throughout the thickness of the electrode, ionic and electronic conductivity should be similar. Assuming a typical electrode with approximately 50% porosity, for standard carbonate electrolytes, at an electrode matrix weight fraction of 10% and ideal application of the Bruggeman relation, a minimum composite matrix conductivity of approximately 20 mS cm⁻¹ is required. A significantly larger conductivity than this benchmark can be achieved by PPy alone (FIG. 4 (a)). However, conductivity decreases exponentially as the CMC to PPy ratio increases. As an anionic dopant in PPy, CMC increases the distance between PPy polymer strands and is expected to increase the resistance to interchain electron transport. Moreover, surplus CMC could act as a non-conductive filler between conductive particles in the composite, resulting in the typical conductivity behavior observed for composites of conductive and non-conductive particles.

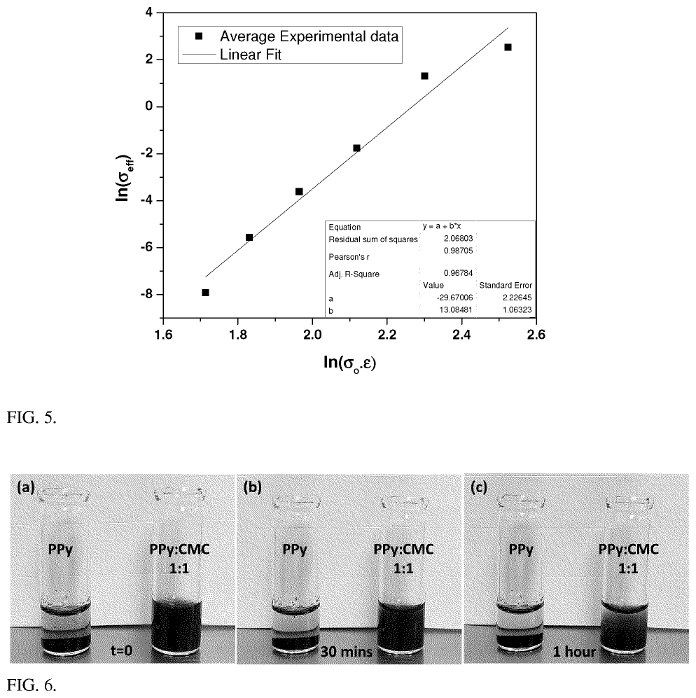

According to the effective medium approximation (EMA) theory, the electrical conductivity of composites, composed of spherical insulating particles embedded in a conductive matrix, would follow the Bruggeman relationship. Similar behaviors have been found for randomly distributed spherical conductive and non-conductive particles[45-47]. A simplified Bruggeman equation is described as:

$${σ}_{eff} = {σ}_{o} {ε}^{α}$$

In which, σ_{eff}, σₒ, ε, and α are effective conductivity, intrinsic conductivity, conductive volume fraction, and Bruggeman exponent, respectively. The expected Bruggeman exponent for a random mixture of near-spherical PPy and CMC particles is close to 1.5. Yet, a fit of the data reveals an exponent of 13.08 (FIG. 5). This significant deviation from typical Bruggeman behavior is consistent with increased energy barriers to electron conduction with CMC content. While this effect reduces the conductivity of the composite significantly, the benchmark conductivity can be obtained with PPy:CMC composites that contain CMC at a weight ratio of CMC:PPy of 0.75 or less.

### Electrode Adhesion and Cohesion

The matrix should not only be conductive but be easily processed, ideally through tape casting. Aqueous processing requires a stable dispersion of the matrix in water. While a PPy suspension settles quickly, PPy:CMC dispersions are stable for an hour (FIG. 6). FIG. 7 shows the appearance of a LiCoO₂/(PPy:CMC 1:1 R2.5) electrode fabricated with water as the solvent. The LiCoO₂/(PPy:CMC 1:1 R2.5) (90:10 wt %) composite film can adhere to the Al substrate without cracking or delamination. Reducing the CMC content in the composite structure could decrease dispersion stability and current collector adhesion of the composite electrode.

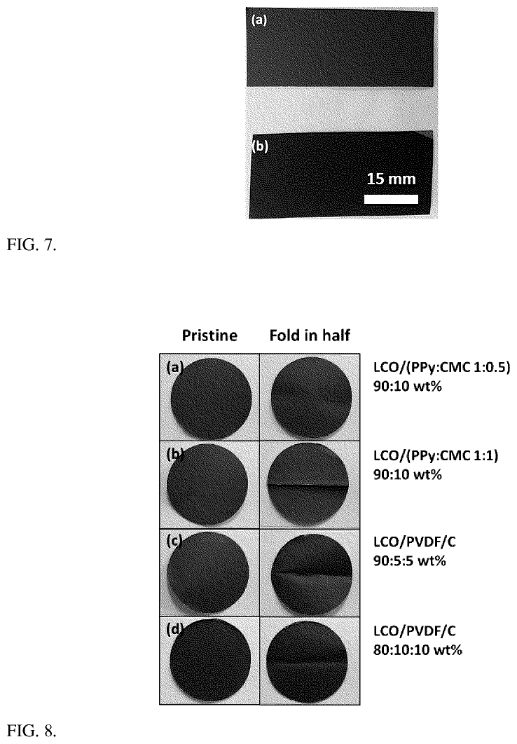

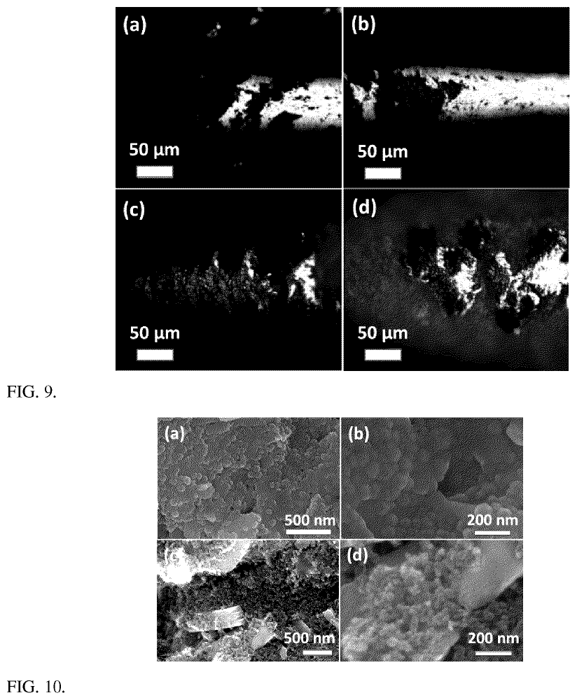

FIG. 8 depicts images of LiCoO₂/PPy:CMC and LiCoO₂/PVDF/C electrodes that adhere to Al foil without noticeable detachment. Upon folding electrodes, minor cracks are observed at the fold in the case of LiCoO₂/PPy:CMC electrodes, originating from the intrinsic brittleness of PPy[48,49]. Nonetheless, all electrodes remain in good contact without any detachment from the current collector. Scratch testing was performed to quantitatively evaluate the adhesion strength of different electrodes to an Al current collector (FIG. 9 (b)). Micrographs of the formed scratch show adhesion failure points where first detachment from the Al substrate is observed, and where this detachment becomes persistent (FIG. 9). The LiCoO₂/(PPy:CMC 1:1 R2.5) electrode requires a consistently higher normal load to achieve both failures, suggesting a stronger adhesion to Al foil than the LiCoO₂/PVDF/C electrode. The load required to cause full electrode delamination for the LiCoO₂/(PPy:CMC 1:1 R2.5) electrode is approximately 60% higher than that for the LiCoO₂/PVDF/C electrode.

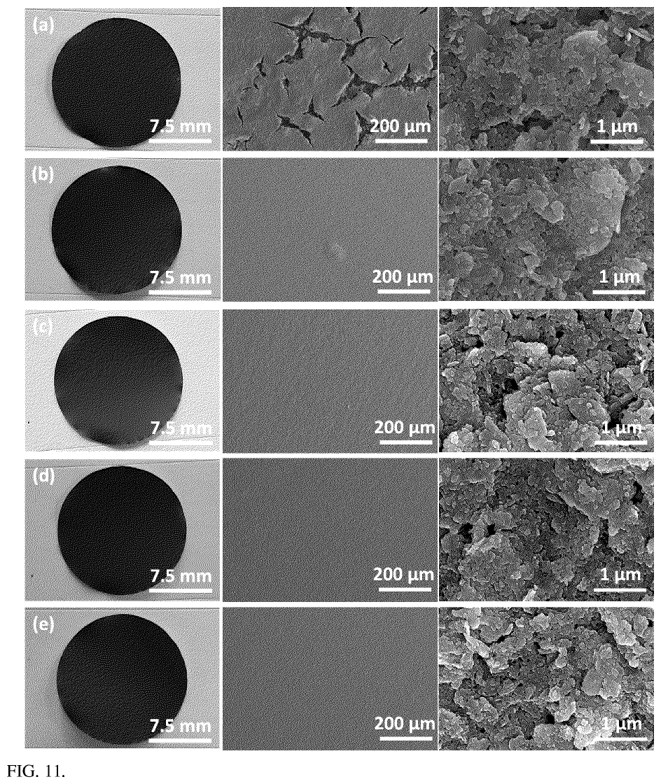

FIG. 10 shows SEM images of electrodes with different electrode matrices. FIG. 10 (c,d) shows a random distribution of PVDF/C around LiCoO₂ particles, including bare LiCoO₂ particle surfaces, and agglomerations of the PVDF/C matrix, which is typical for the weak interactions of the non-polar PVDF/C surface with the polar LiCoO₂ particle surfaces. The PPy:CMC matrix, on the other hand, is coating the LiCoO₂ surface completely, confirming the greater affinity of PPy:CMC composites toward LiCoO₂. Together, the mechanical properties and observed electrode microstructure with PPy:CMC composites are promising good binding performance of PPy:CMC composites.

FIG. 11 depicts the digital and SEM images of electrodes with different PPy:CMC composites. Some cracking was observed for the LiCoO₂ (PPy:CMC 1:0.25 R2.5) electrode. While other electrodes showed relatively smooth surfaces. SEM imaging further confirmed the poor electrode cohesion of LiCoO₂ (PPy:CMC 1:0.25 R2.5) electrode, where LiCoO₂ particles were not sufficiently covered by PPy:CMC composite. Meanwhile, no significant difference in electrode morphology was observed for other electrodes. The result suggests that low CMC content is associated with a lack of adhesive properties within electrode matrices.

### Electrochemical Performance

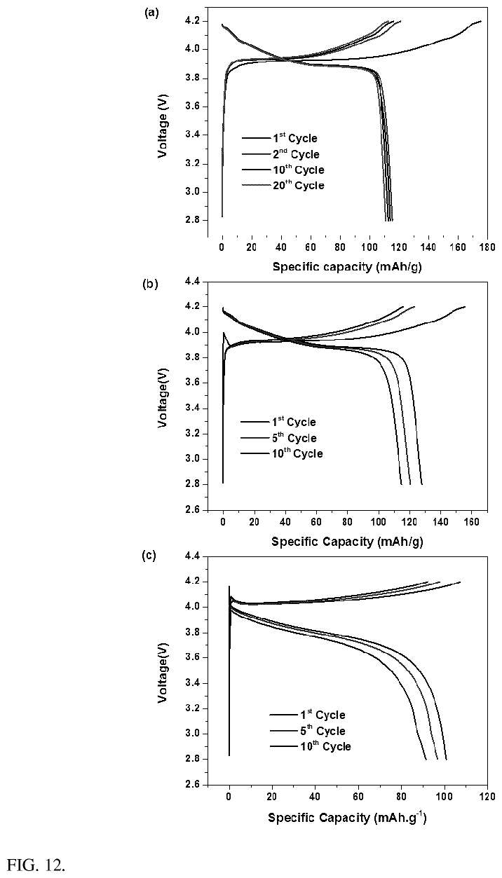

To evaluate the performance of PPy:CMC composites as electrode matrices, electrodes with different PPy:CMC or PVDF/C matrices were subjected to galvanostatic cycling. LiCoO₂/(PPy:CMC 1:1 R2.75) electrodes can be cycled at 27.4 mA g⁻¹ (0.1 C) and 274 mA g⁻¹ (1 C) with similar initial capacity as the benchmark LiCoO₂/PVDF/C electrodes (FIG. 12). Different from standard electrode matrices, PPy:CMC composites can be oxidized and reduced, which can contribute to the overall electrode capacity. With regular small-ion dopants, the anionic dopant is released from PPy upon reduction. However, when using polyanions as dopants, the reduction of PPy leads to the intercalation of small cations into the polymer[50]. As such, the PPy:CMC matrix can act as additional charge-storage material with a behavior that is analog to traditional Li⁺ intercalation materials.

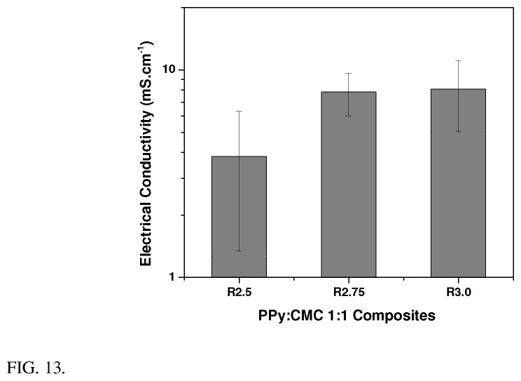

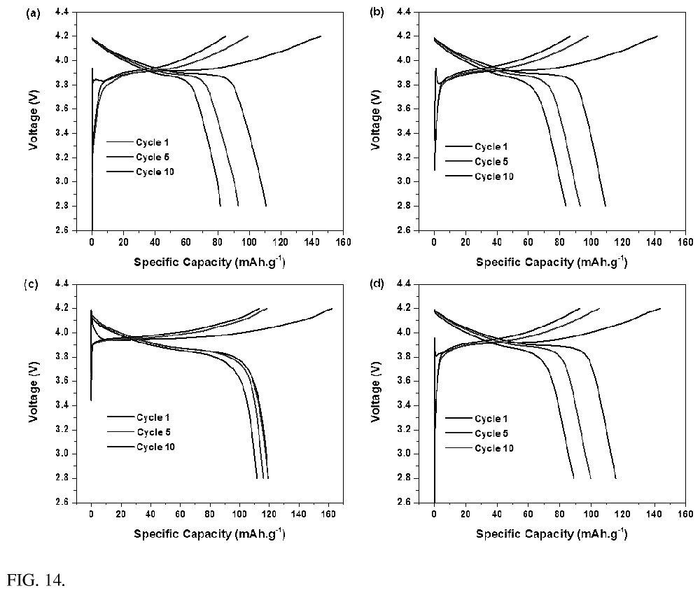

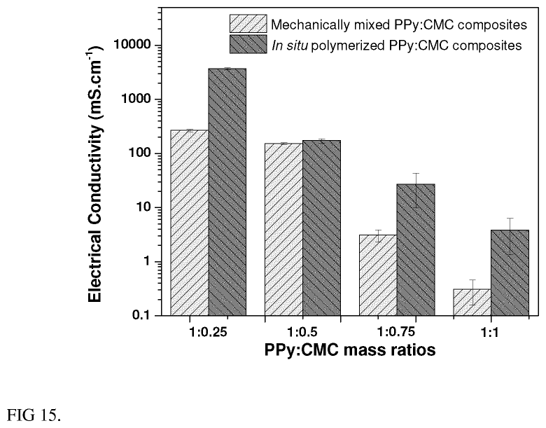

It should be noted that lower electrode performance is observed with the typically suggested Py:Fe ratio of 2.5 (denoted as R2.5) during the polymerization[36,51,52], but an increased equivalent of FeCl₃ was required of 2.75 (denoted as R2.75). This is likely due to a small amount of ferric chloride being captured by CMC[53], as observed in the XPS results. As a result, PPy:CMC 1:1 R2.75 composite exhibited higher electrical conductivity than PPy:CMC 1:1 R2.5 composite (FIG. 13). Moreover, the amount of CMC in PPy:CMC composites significantly affected electrode performance (FIG. 14). Too low CMC content in PPy:CMC composite composition results in poor electrode cohesion/adhesion. Based on the morphological observations, this is likely a result of poor adhesion (FIG. 11). Consequently, LiCoO₂/(PPy:CMC 1:0.25 R2.5) electrodes exhibited too large internal resistance to cycle at 0.1 C. Raising CMC content improves accessible capacity and cycling performance up to the composition PPy:CMC 1:1 R2.5. Raising the CMC content further leads again to a drop in performance, likely due to reduced electrical conductivity at such compositions (FIG. 4 (a)). Interestingly, mechanically mixed PPy:CMC composites showed a significantly lower electrical conductivity than in situ polymerized counterparts (FIG. 15). Consequently, an electrode with mechanically mixed PPy:CMC 1:1 matrix cannot be cycled at 0.1 C. highlighting the importance of in situ polymerization of PPy in the presence of CMC to achieve sufficiently conductive nano-composite electrode matrices. This confirms that the observed distinct microscopic structures between mechanically mixed and in situ polymerized samples has significant performance implications.

While the initial cycling performance of PPy:CMC electrodes is similar to standard PVDF/C electrodes, capacity fading is observed almost immediately with the PPy:CMC matrices. This fade is correlated with a swift increase in internal resistance. There are several possible reasons for this performance decay. While plenty of publications show long performance stability of conducting polymer-containing electrodes[54], there is little targeted research on the compatibility and stability of conducting polymers in Li-ion batteries[55]. It is possible that conducting polymer performance decay is underestimated in many studies, where carbon additives and conducting polymers are used together, due to the reduced impact that conducting polymer conductivity has on electrode performance. In targeting the full replacement of carbon additives to avoid agglomeration, long-term conducting polymer performance becomes critical and is now the subject of ongoing work in our group. LiCoO₂/(PPy:CMC) cells also exhibited an initial spike in cell voltage followed by a descent in the first charging step. A number of processes could lead to this behavior including slow electrolyte infiltration or doping of PPy by the electrolyte.

### Conclusions

This work demonstrates the design concept of water-dispersible, self-conductive electrode matrices from conducting polymer composites synthesized via a simple and scalable in situ polymerization. Multifunctional PPy:CMC composites, that exhibit adhesion, electronic conductivity, and contribute to charge storage are a promising replacement for PVDF and carbon additives in electrodes to reduce carbon agglomeration and achieve a conductive electrode network that actively adheres to intercalation materials during cycling. We demonstrated that a LiCoO₂/PPy:CMC electrode can be cycled at a high current density of 274 mA·g⁻¹ without carbon additives, which is a unique achievement within carbon-free Lithium intercalation cathodes. At the same time, the conductive network within the electrode appears to deteriorate during cycling, which is the subject of ongoing work.

Notwithstanding the stability limitations, this study highlights the performance potential of battery electrodes containing conducting polymer composite matrices. Those matrices are produced from low-cost, high-volume raw materials, are easily synthesized and processed in low-cost, low-impact aqueous solutions. As new electrode materials are developed with ever-increasing energy densities, the potential for larger volume change increases as well. This will require a solution to the intrinsic lack of adhesion between carbonaceous conductors and active materials, of which conducting polymer composites are shown here to be a promising candidate.

### Example 2—Carbon-Additive-Free LiNi_{1/3}Mn_{1/3}Co_{1/3}O₂ Cathode Enabled by Conducting Polymer-Based Electrode Matrix

### Synthesis and Characterization

### Synthesis of PPy:CMC Composite

In brief, pyrrole (Sigma-Aldrich, 98%), was chemically polymerized by FeCl₃ oxidant (Fisher, 98%) in the aqueous solution of Na-CMC (Sigma-Aldrich, MW=˜250.000 g/mol, degree of substitution 0.9) as described in the EXAMPLE 1. In EXAMPLE 2, pyrrole:Na-CMC mass ratio and pyrrole:FeCl₃ molar ratio were fixed at 1:1 and 1:2.75, respectively. To simplify the notation, the PPy:CMC11-R275 composite as denoted in the EXAMPLE 1 will be denoted simply as PPy:CMC composite. After synthesis, PPy:CMC composite was purified and dried as described detail in EXAMPLE 1.

Synthesis of LiNi_{0.33}Mn_{0.33}Co_{0.33}O₂ (NMC111)

NMC111 was synthesized by a sol-gel method that followed the synthesis procedure reported by previous work[56]. CH₃COOLi·2H₂O (Sigma-Alrich, 98%), (CH₃COO)₂Ni·4H₂O (Sigma-Alrich, 98%), (CH₃COO)₂Mn·4H₂O (Sigma-Alrich, 98%), (CH₃COO)₂Co·4H₂O (Sigma-Aldrich, 98%) and citric acid (Sigma-Aldrich, 98%) were used as received without any purification. Firstly, acetate salts were dissolved together in DI water with the Li:Ni:Mn:Co ratio of 1.1:0.33:0.33:0.33. Citric acid (Sigma-Aldrich, 98%) was dissolved completely in DI water, mixed with ethylene glycol (Sigma-Aldrich, 99.8%), and then slowly added to the NMC precursor solution. The molar ratio between citric acid and total metal ions was 1:1. The solution was heated to 70° C. overnight to yield a pink gel that was then kept at 70° C. for 2 days. The dried gel was ground and transferred to a ceramic crucible before putting in a furnace. The sample was pre-calcinated at 450° C. for 2 hours to burn out organic components. The powder was ground and compressed into pellets at 25 MPa. The calcination was performed at 900° C. for 12 hours in air. A heating rate of 2° C.·min⁻¹ was used throughout the experiment. The final product was ground by mortar and pestle into fine powders and dried in a vacuum oven before use.

### Electrode Preparation and Coin Cell Fabrication

NMC111/PPy:CMC cathode was prepared by mixing NMC111 powder with PPy:CMC composite (PPy:CMC 1:1 R2.75) at a mass ratio of 90:10 wt %. The solid mixture was dispersed in water with a solid content of 30 wt % and then stirred vigorously on a magnetic stirrer for 6 hours. A homogenous electrode slurry was cast on aluminum to yield ˜25 μm-thick electrode sheets on 25 μm-thick Al foil (Goodfellow, USA) by using a doctor blade. For comparison, NMC111/PVDF/C (90:5:5 wt %) reference cathode was prepared in N-Methyl-2-Pyrrolidone (NMP) solvent by a similar procedure. Electrode mass loading was controlled at approximately 3 mg·cm⁻². Electrode sheets were carefully dried in a vacuum oven at 80° C. for two days and cut into 15-mm in diameter electrode disks before use.

CR2032-type coin cells (MTI, USA) were used to fabricate half-cell Li-ion batteries for testing cathode performance. Coin cell fabrication was performed in an argon-filled glove box (Unilab Mbraun) with oxygen and moisture level below 0.1 ppm. Each coin cell contains 15 mm disc cathode, 20 mm disc glass fiber separator (Whatman™), 15 mm lithium disc (Alfar Aesar, 99.9%, 0.75 mm thick, LiPF₆ in DMC/EC (50:50 v/v) electrolyte (Sigma-Aldrich).

### Material Characterization

The crystal structure of NMC111 cathode materials was confirmed by powder X-ray diffraction (XRD) measurement on the D4 Endeavor instrument with Cu Kα source at a working voltage of 40 kV. Data treatment was performed on QuaIX software with Crystallography Open Database[57]. The morphologies of NMC111 were studied by SEM (FEI Nova NanoSEM 450) and TEM/EDX (FEI Talos F200X S/TEM).

### Electrochemical and Post-Mortem Analyses

Coin cells were galvanostatically charged and discharged within the fixed potential window of 3.0 V-4.3 V Li/Li⁺ on Neware battery testers. The applied current density of 275 mA·g⁻¹, 27.5 mA·g⁻¹, and 13.75 mA·g⁻¹ were denoted as 1 C, 0.1 C, and 0.05 C-rate, respectively.

After cycling for 100 cycles at 1 C, a coin cell was opened in an argon-filled glovebox. Cathode material was disassembled and then washed in propylene carbonate (PC) solvent. The washed cathode was dried in a vacuum oven at 85° C. for 2 days. The sample was then stored in the argon-filled glovebox prior to mount on the sample holder for SEM measurement.

### Results and Discussion

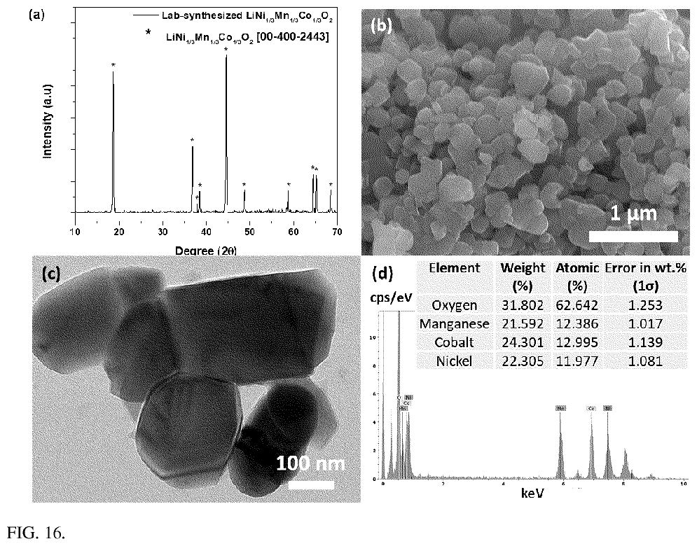

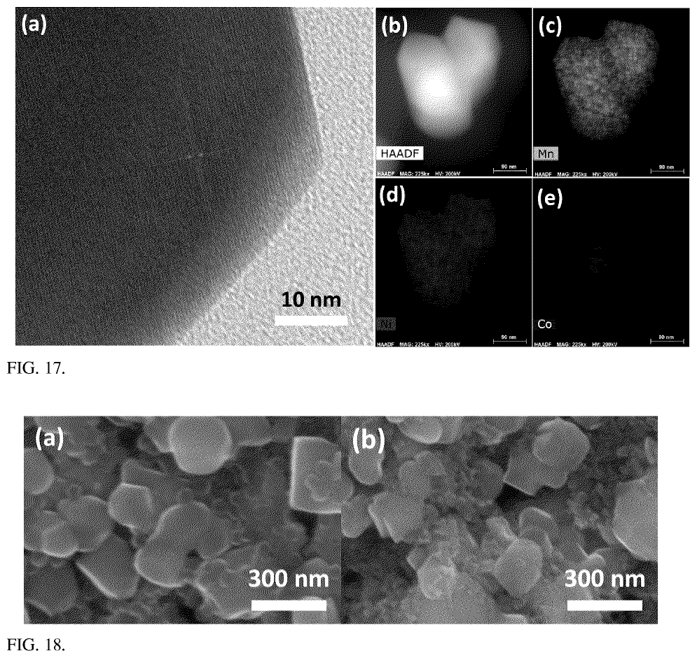

The structure of lab-synthesized LiNi_{0.33}Mn_{0.33}Co_{0.33}O₂ (NMC111) cathode materials was confirmed by powder X-ray diffraction. FIG. 16 (a) shows that major X-ray diffraction peaks were identical to the NMC111 standard structure[58]. NMC111 particles exhibited a narrow size distribution in the range of 200-300 nm as confirmed by SEM and TEM (FIG. 16 (b,c)). EDX analysis suggested that the molar ratio between transition metal ions was close to the desired value. The HRTEM shows crystallinity reaches the particle surface (FIG. 17 (a)). Homogeneous distribution of Mn, Ni, and Co elements was confirmed by elemental mapping (FIG. 17 (b,c,d,e)).

A comparison between the morphologies of NMC111-based electrodes with PVDF/C and PPy:CMC electrode matrices was demonstrated in FIG. 18. The PPy:CMC composite showed greater adhesion towards the surface of NMC111 particles compared to that of PVDF/C, which loosely surrounded NMC111 nanoparticles. The good surface affinity of the PPy:CMC composite was consistent with the result from a previous study on LiCoO₂/PPy:CMC cathodes[59] as reported in EXAMPLE 1. In contrast with a non-polar PVDF/C mixture, the PPy:CMC composite was composed of charged molecules, allowing them to form stronger intermolecular interactions with NMC particles. In addition, their strong surface adhesion to NMC particles could be attributed to the abundance of hydroxyl and carboxyl groups on the structure of CMC. This explanation was in agreement with other studies, where they claimed the strong surface adhesion between Li-rich NMC particles and xanthan gum[60], guar gum[61] resulted from a large number of hydroxyl and carboxyl functional groups on the structure of polysaccharide gums.

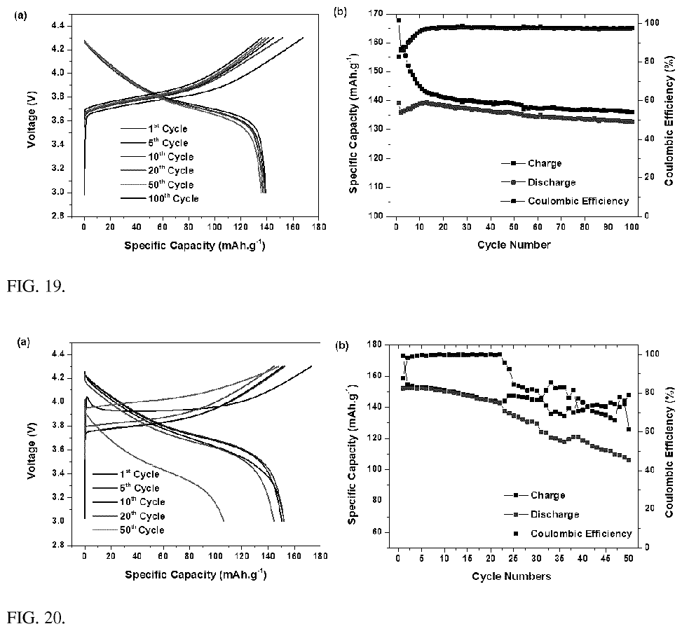

The NMC111/PVDF/C reference cathode showed great capacity retention, maintaining a specific discharge capacity of approximately 135 mAh·g⁻¹ after 100 cycles at 0.1 C (27.5 mA·g⁻¹). In comparison to the NMC111/PVDF/C reference cathode, NMC111/PPy:CMC cathode demonstrated a higher initial discharge capacity of 150 mAh·g⁻¹ (FIG. 20). As for the presented battery cell, however, there was a noticeable decrease in electrode performance from the 23^{rd} cycle due to unknown reasons. Other battery coin cells with similar NMC111/PPy:CMC cathode composition also suffered from unexpected capacity fading or shorting after running for 30-50 cycles. The underlying reasons for this poor life cycle are unknown, but they might result from parasitic reactions between NMC111, PPy:CMC composite and electrolytes

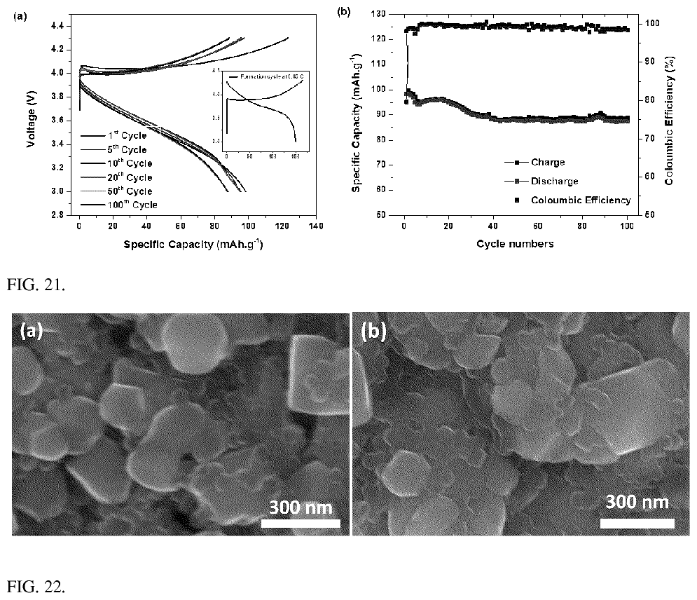

Nonetheless, carbon-additive-free NMC111/PPy:CMC cathode was able to operate at 1 C with great capacity retention. After cycling for 100 cycles at 1 C, they still delivered ˜90 mAh·g⁻¹ (FIG. 21). The result confirmed that the PPy:CMC composite provided sufficient electrical conductivity for NMC111 active materials to run without using carbon additives. Despite having lower intrinsic electrical conductivity than carbon black, the high affinity toward NMC111 of the PPy:CMC composite allowed them to offer a great electrical connection between individual NMC111 particles.

To investigate changes in the morphology of NMC/PPy:CMC cathode upon repeated charge/discharge cycling at 1 C for 100 cycles, the NMC/PPy:CMC coin cell was disassembled. The cycled NMC/PPy:CMC cathode was characterized by SEM. FIG. 22 shows that no distinct changes in the morphology of NMC/PPy:CMC cathode were observed. PPy:CMC composite still covered NMC111 particles sufficiently.

The sudden capacity fading of NMC111/PPy:CMC cathode after operating for more than 20 cycles at 0.1 C could have resulted from unknown side reactions. However, the cell that cycled at 1 C demonstrated relatively stable performance. It is worth noting that cycling at 1 C is theoretically 10 times faster than cycling at 0.1 C. For that reason, the sudden cell failure after cycling for 20 cycles at 0.1 C might not be observed after cycling for 100 cycles at 1 C. Unlike the cycle life, which is closely related to the performance degradation due to electrochemical reactions during the repeated charge/discharge cycles, the calendar life depends on the operating time of battery cells rather than the cycle number. The discrepancy in the performance of NMC111/PPy:CMC cathode cycled at 1 C and 0.1 C rate could be attributed to their limited calendar life, indicating some unwanted chemical reactions occurred between battery components.

### Conclusions

The study has shown that PPy:CMC composites are versatile for usage as electrode matrices for different types of intercalation materials ranging from traditional LiCoO₂ to NMC111. PPy:CMC composite plays dual roles as electrode binder and conductor. Despite having very low intrinsic electrical conductivity as mentioned in EXAMPLE 1, PPy:CMC composite was capable of providing a sufficient conductive matrix for NMC111 particles thanks to their strong adhesion with NMC111 particles. As a result, carbon-additive-free NMC111/PPy:CMC cathode could cycle at a high C-rate. The result suggests that the electrical conductivity of battery electrodes depends not only on the intrinsic electrical conductivity of conductive agents but also on how conductive agents interact with active materials.

### Example 3: Revisiting the Degradation of Li-Ion Battery Electrode Containing Conducting Polymer-Based Electrode Matrix

### Synthesis and Characterization

### Material Synthesis

PPy:CMC composites were synthesized by chemically in-situ polymerizing pyrrole in aqueous sodium carboxymethyl cellulose solution with FeCl₃ as oxidant as reported in the EXAMPLE 1. The PPy:CMC composite that was synthesized with Py:Na-CMC 1:1 mass ratio and Py:FeCl₃ 1:2.75 molar ratio yielded the best electrode performance. Therefore, PPy:CMC11 R2.75 composite was chosen to study in this example. The PPy:CMC 1:1 R2.75 composite reported in the EXAMPLE 1 was now denoted as PPy:CMC composite for simplicity.

### Electrode Preparation and Coin Cell Fabrication

Carbon-additive-free LiCoO₂/PPy:CMC cathodes (90:10 wt %) were prepared by ball-milling a mixture of LiCoO₂ and PPy:CMC composite in water. The electrode slurry was then cast on a hard temper Al current collector[59]. Reference LiCoO₂/PVDF/C (90:5:5 wt %) cathodes were prepared by a similar procedure in NMP solvent. PPy:CMC-only cathodes were made by compressing 25 mg of PPy:CMC composite into ˜0.1 mm-thick, 13 mm diameter pellets. R2032 coin cell fabrication was carried out in an argon-filled glovebox. LiCoO₂/PPy:CMC, LiCoO₂/PVDF/C, or PPy:CMC-pellet were used as cathodes. Lithium metal (Alfar Aesar, 99.9%, 0.75 mm thick) and glass-fiber (Whatman™) were used as anode, and separator, respectively. All coin cells used LiPF₆ in DMC/EC (50:50 v/v) (Sigma-Aldrich) as liquid electrolyte unless otherwise specified.

### Electrochemical and Post-Mortem Analyses

LiCoO₂/PPy:CMC coin cells underwent galvanostatic charge/discharge at 0.1 C (27.4 mA·g⁻¹) for 1 cycle, 10 cycles, and 100 cycles within a voltage range of 2.8 V-4.2 V vs Li/Li⁺ on Neware battery testers. After undergoing certain cycling numbers, coin cells were disassembled in an argon-filled glovebox. Cathode materials, that were attached to Al foil, were immersed in propylene carbonate 3 times (5 mins/each) and then dried in a vacuum oven at 85° C. for 2 days. Samples were stored in the argon-filled glovebox prior to mount on the sample holder for SEM (FEI Nova NanoSEM 450) and XPS (Kratos Axis Nova spectrometer, Al X-ray source) measurements.

Galvanostatic electrochemical impedance spectroscopy (EIS) measurement was carried out on coin cells assembled with LiCoO₂/PVDF/C reference cathode or LiCoO₂/PPy:CMC cathode. Frequencies were scanned from 100 kHz to 10 mHz by Interface 1010E (Gamry Instrument). EIS equivalent circuit fitting was performed on Gamry Echem Analyst by the simplex method. Cyclic voltammetry (CV) was carried out within two potential ranges of 2.8-4.2 V vs Li/Li⁺ and 0-5 V vs Li/Li⁺ on CR2032 coin cells assembled with ˜0.1 mm thick PPy:CMC pellets as cathode materials.

### Results and Discussion

### Electrochemical Analyses of PPy:CMC Composite and LiCoO₂/PPy:CMC Cathode

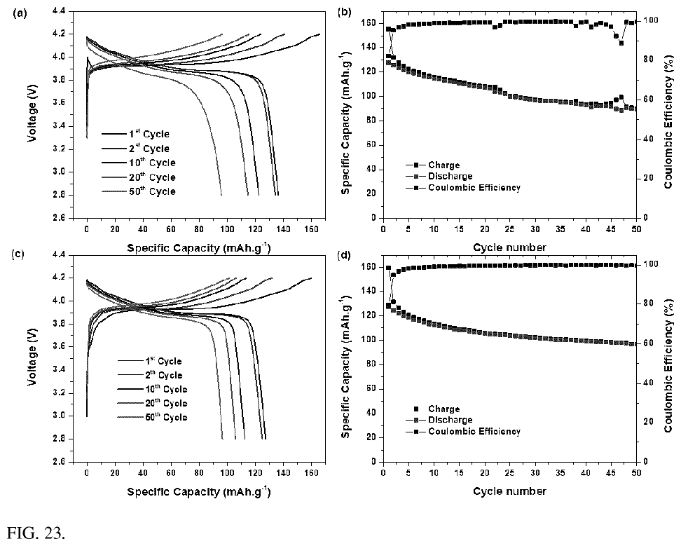

FIG. 23 shows a similar magnitude of capacity fading within the first 50 cycles of LiCoO₂/PVDF/C reference cathode and LiCoO₂/PPy:CMC cathode. The question was whether the two cathodes shared a similar degradation mechanism. The performance of carbon-additive-free LiCoO₂/PPy:CMC cathode would depend on the electrochemical and chemical properties of PPy:CMC composite and their interactions with other battery components such as LiCoO₂ and electrolytes. Understanding the stability of PPy:CMC composite in Li-ion battery working conditions would be beneficial for the adoption of other CP-based electrode matrices.

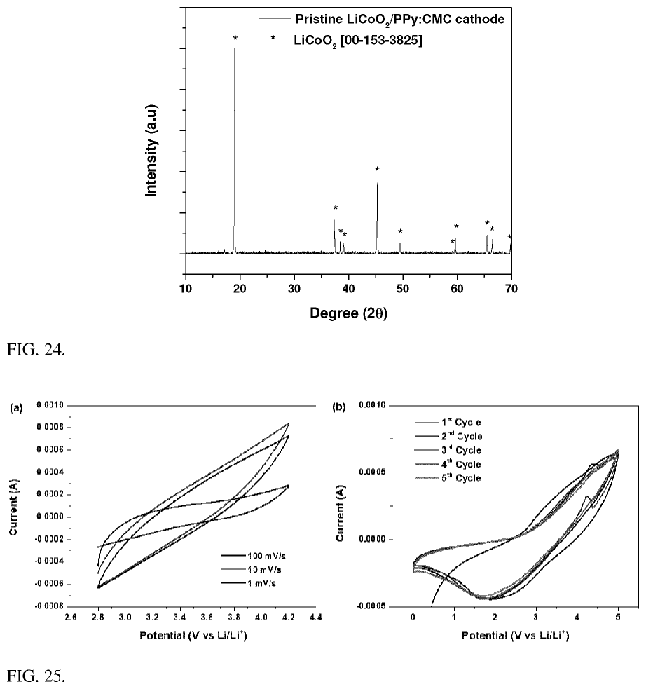

FIG. 24 shows the XRD diffractogram of LiCoO₂/PPy:CMC powder prepared by ball-milling LiCoO₂ with PPy:CMC composite for 6 hours in water. There was no noticeable change in the structure of LiCoO₂, suggesting no noticeable chemical reaction between PPy:CMC composite and LiCoO₂ during electrode slurry preparation.

According to the voltage profiles of LiCoO₂/PVDF/C reference cathode in FIG. 23 (c), during the charging process, the cell voltage normally increases fast to ˜3.6 V vs Li/Li⁺ and then slowly go up to 4.2 V vs Li/Li⁺ during the de-lithiation of LiCoO₂ following the reaction: LiCoO₂→Li₁₋ₓCoO₂+xLi⁺+xe⁻. However, as shown in FIG. 23 (a), the voltage profile of LiCoO₂/PPy:CMC cathode in the first charging cycle was unique. There was a sharp voltage increase to approximately 4.0 V vs Li/Li⁺ followed by a rapid voltage decline. This unique voltage profile has been seen for many LiCoO₂/PPy:CMC cathodes with different PPy:CMC composites as mentioned in the Example 1. This voltage behavior could be attributed to the oxidation of neutral/undoped PPy in the as-prepared PPy:CMC composite. Undoped PPy molecules were expected to be oxidized and doped by anionic dopants. More importantly, the oxidation of neutral PPy in PPy:CMC composite occurred only in the first charging step (FIG. 23 (a)), suggesting that PPy remained fully-doped within the potential window of cathode regardless of further charge/discharge processes.

The electrochemical behavior of PPy:CMC composite at the cathode working potentials was tested by performing cyclic voltammetry measurement on PPy:CMC-pellet coin cells. Within the cathode operating potential window, there was no redox reaction observed as shown in FIG. 23 (a). Cycling beyond that voltage range provided some characteristic redox information of PPy:CMC composite (FIG. 25 (b)). In the first cycle, a low-intensity oxidation peak between 2.5 V to 4.0 V vs Li/Li⁺ indicated the oxidation of undoped PPy molecules, yielding fully-charged PPy molecules in PPy:CMC composite. In the subsequent CV cycle, there was a reduction peak at around 1.5 V vs Li/Li⁺ (FIG. 25 (b)). Over multiple cycles, these redox processes remained reversible with oxidation and reduction onset near 3V vs. Li/Li⁺. Oxidation is kinetically slow, peaking beyond the 5V potential window, which limits the amount of charge passed within the typical cathode battery cycling window. However, there was no additional redox peak within the voltage window of the cathode. The results indicated that PPy:CMC composite was electrochemically stable at the cathode side.

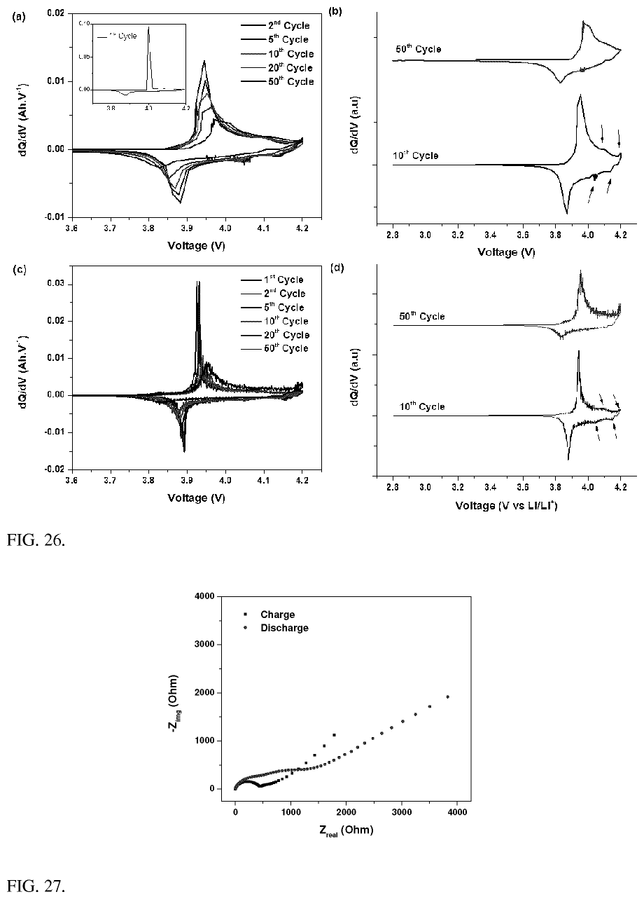

FIG. 26 (a,c) compares the differential capacity (dQ/dV) diagrams of LiCoO₂/PPy:CMC and LiCoO₂/PVDF/C cathodes. In comparison to LiCoO₂/PVDF/C reference cathode, LiCoO₂/PPy:CMC cathode showed faster Co³⁺/Co⁴⁺ redox peak shift during the phase transition of LiCoO₂↔Li₁₋ₓCoO₂, which correlated to the higher electrode polarization as the cycle number increased. The results indicated that the overall electrical conductivity of LiCoO₂/PPy:CMC cathode decreased relatively faster than that of LiCoO₂/PVDF/C reference cathode. The reduction of peak intensity at two reversible reduction/oxidation events at 4.03 V/4.07 V and 4.15 V/4.19 V that are corresponded to the transition between ordered and disordered lithium ions in CoO₂ structure during (de) lithiation process (FIG. 26 (b,d))[62,63], suggesting the depletion of electrochemically accessible LiCoO₂ upon cycling for both cathodes.

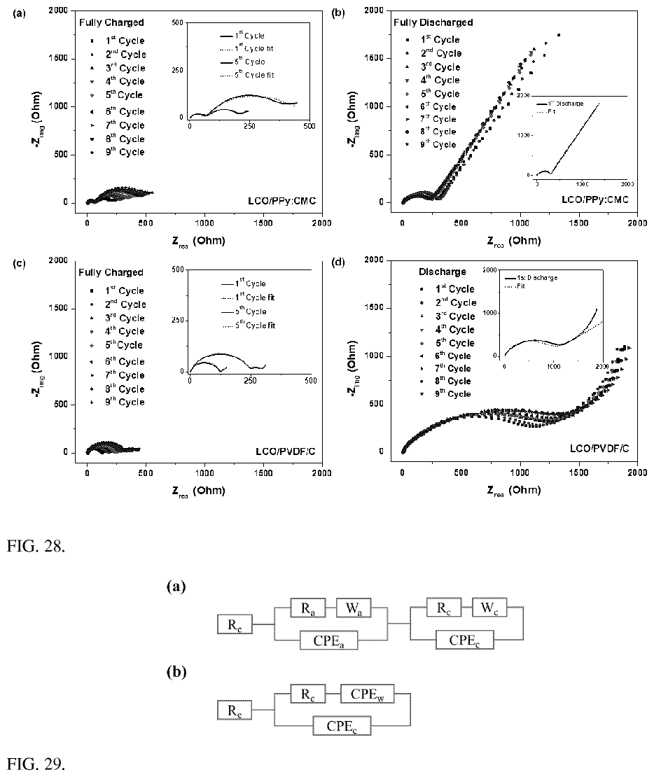

The evolution of electrode impedance after each charge/discharge process would provide information about electrochemical processes that occurred in battery cells. In contrast to the coin cell assembled with LiCoO₂/PVDF/C cathode, interestingly, the as-prepared coin cell assembled with LiCoO₂/PPy:CMC cathode did not yield any charge and discharge capacities during the first charge/discharge coupled with EIS measurement. As shown in FIG. 27, there were high impedances in both charge and discharge conditions. A possible explanation is that undoped PPy molecule in the pristine PPy:CMC composite needed to be oxidized and then doped by electrolyte anions to become electrically conductive. After the first failed charge/discharge cycle, the coin cell assembled with LiCoO₂/PPy:CMC cathode started to deliver expected charge/discharge capacities with much lower impedances in the first workable charge and discharge steps as shown in FIG. 28 (a,b).

FIG. 29 describes the proposed equivalent circuit at fully charged (a) and fully discharged (b) states of coin cells assembled with LiCoO₂/PPy:CMC cathode (FIG. 28 (a,b)), and LiCoO₂/PVDF/C reference cathode (FIG. 28 (c,d)). At the fully charged state (FIG. 28 (a)), electrolyte resistance (Rₑ), recorded at the high frequency, was as small as 2-3 Ohm for the coin cells studied, Therefore, it is usually ignored. There were two Randles circuits at high and medium frequencies, representing impedance at anode and cathode, respectively. The Randles circuit typically consists of charge transfer resistance in series with Walburg element, which was then connected in parallel with the constant phase element (CPE). At the fully discharged state, LiCoO₂ was in its original composition. The equivalent circuit consisted of one Randle circuit representing cathode impedance (FIG. 29 (b)). The perfect Warburg diffusion element was a constant phase element (CPE) with a phase of 45°, yielding a 45° straight line at low frequencies. To yield the best fit for the LiCoO₂/PPy:CMC coin cell, the Warburg element was replaced by a CPE_{w}, whose phase was different from 45°.

At the fully charged state, there were two clear depressed semi-circles at high and medium frequencies corresponded to two Randles circuits at anode and cathode, respectively. The impedance evolution routes for the two coin cells were different. As the cycle number increased, the anode charge transfer resistance (R_{ct}) of the reference LiCoO₂/PVDF/C coin cell increased relatively fast (FIG. 28 (c)) while the cathode Ret slowly increased, indicating stable electrical conductivity of the LiCoO₂/PVDF/C cathode. In contrast, the anode Ret of LiCoO₂/PPy:CMC coin cell did not change after 5 cycles. But there was a rapid increase in cathode Ret, which was relevant to the differential capacity analysis result (FIG. 26 (a)). This observation may support the hypothesis that high surface coverage of PPy:CMC composite on LiCoO₂ particles prevents lithium ions from re-entering LiₓCoO₂ structure in the fully charged state.

In the fully discharged state, It was clear that LiCoO₂/PVDF/C reference cathode showed higher cathode impedance than LiCoO₂/PPy:CMC cathode. As discussed in the EXAMPLE 1, the intrinsic electrical conductivity of as-prepared PPy:CMC composite was 10 000 times lower than that of carbon black additives. However, PPy:CMC composite seemed to offer better electrical conductivity for LiCoO₂ electrode than PVDF/C electrode matrix. There are several possible explanations. Firstly, undoped PPy molecules in PPy:CMC composite were likely to be oxidized and doped by polyanions and anions from battery electrolyte during the first charging process of battery cells. As a result, the actual electrical conductivity of PPy:CMC composite in Li-ion battery cells was higher than that of their pristine state. Secondly, PPy:CMC composite adhered strongly on the surface of LiCoO₂ particles, thus providing good electrical conduction from particle to particle. In contrast, most carbon additives do not adhere to LiCoO₂ particles and are trapped inside the non-conductive PVDF binder, which reduces the effective electrical conductivity of the PVDF/C electrode matrix.

### Post-Mortem Analysis

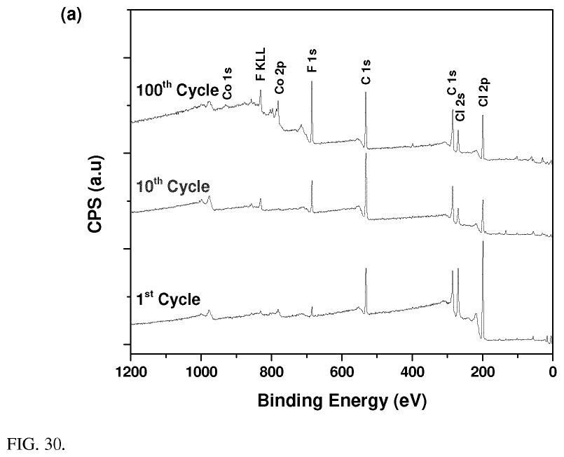

After cycling for several charge/discharge cycles, coin cells were disassembled to characterize morphological and structural changes of LiCoO₂/PPy:CMC cathode upon cycling. XPS survey spectra (FIG. 30) showed that chloride ions were not completely washed from the PPy:CMC composite, which was consistent with XPS data reported in the previous study on PPy:CMC composite in EXAMPLE 1. Several studies even added LiCl into battery electrolyte solution to suppress electrolyte degradation[64] or protect Li metal anode[65]. Chlorine gas evolution has not been reported when chloride-contaminated electrolytes underwent charge/discharge cycling[64,65].

As the cycle number increased, the peak intensity of Cl 2p decreased while the peak intensity of F 1s increased simultaneously. According to the previous study on PPy:CMC composite, positively charged PPy was doped by carboxyl groups (from CMC structure) and residual chloride ions (from residual FeCl₃ oxidant)[59]. Initially, chloride ions were key dopants for PPy, which explained the high peak intensity of Cl 2p in the XPS spectrum of the electrode that cycled for 1 cycle. During the continuous charge/discharge process, PF₆⁻ ions were likely to substitute Cl ions as anionic dopants for PPy due to the excess use of LiPF₆ electrolyte. Free chloride ions were easily washed out during the electrode washing prior to XPS measurement. In contrast, doping Cl⁻ and PF₆⁻ ions were trapped within PPy:CMC electrode matrix. As a result, the XPS spectra for the cathode that cycled 100 times exhibited strong peak intensity for F 1s (FIG. 30).

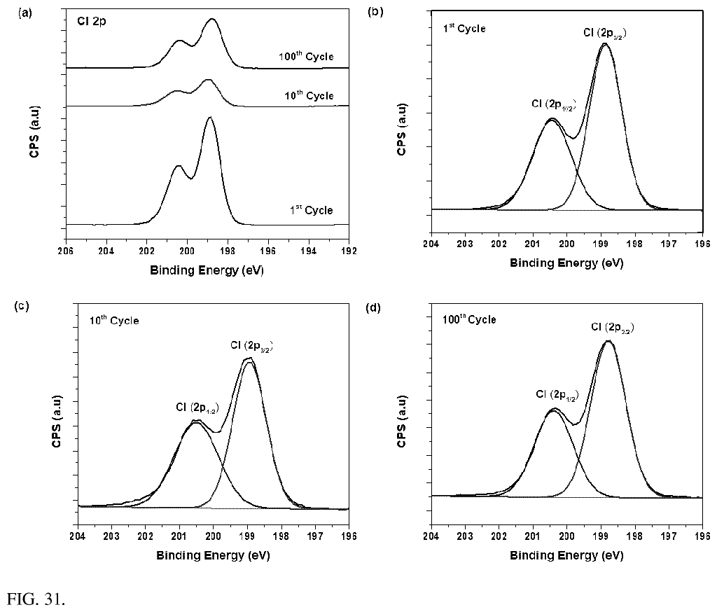

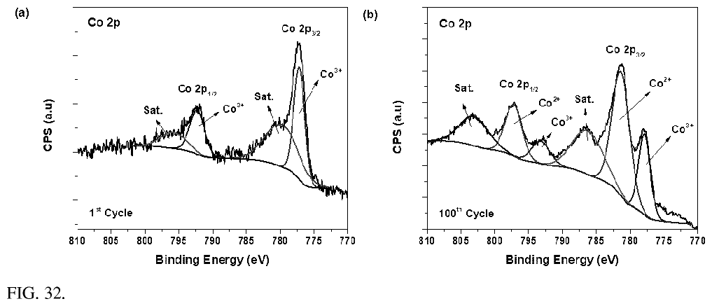

FIG. 31 (b,c,d) shows the consistency of Cl 2p peak doublet regardless of the cycle number, indicating that residual chloride ions did not involve in redox events within the working potential range of cathode.

After cycling for 1 cycle, the Co 2p XPS spectrum of LiCoO₂/PPy:CMC cathode was identical to pristine LiCoO₂ as reported in the previous studies[66]. However, there was a significant change in the Co 2p XPS spectrum of LiCoO₂/PPy:CMC cathode following the 100^{th} cycle. Such changes in the specification of Co 2p peaks indicate changes in the surface structure of LiCoO₂. The question remained whether PPy:CMC composite contribute to the degradation of LiCoO₂ because the magnitude of capacity fading of LiCoO₂/PPy:CMC cathode and LiCoO₂/PVDF/C reference cathode were similar.

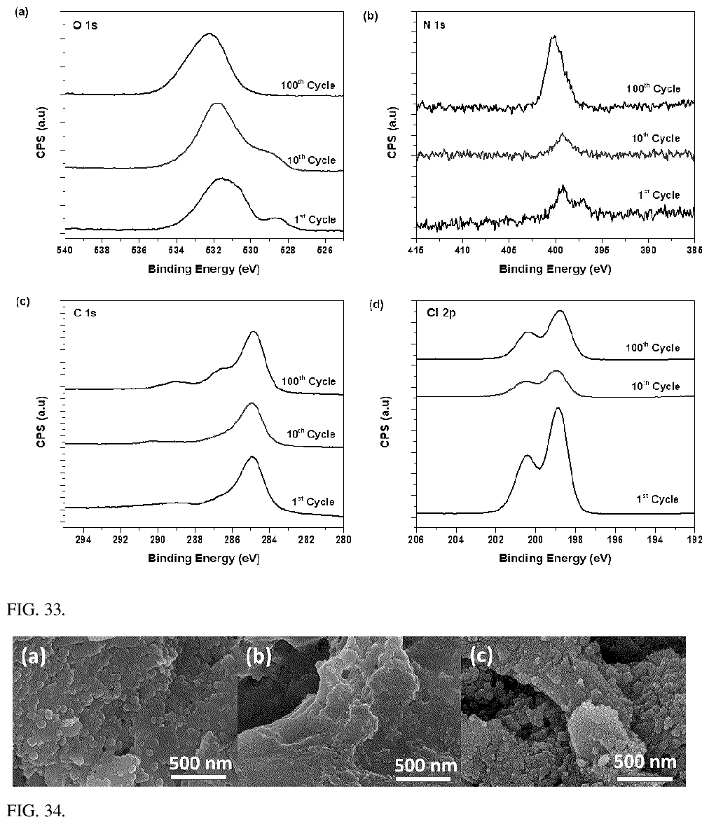

At the 100^{th} cycle, two C 1s peaks appeared at approximately 287 eV and 289 eV that could be attributed to ester and ether groups of CMC (FIG. 33 (c)), suggesting a slow increase in the average oxidation state of carbon as the cycle number increased. The N 1s XPS spectra were shifted to higher binding energy, suggesting increased oxidation state and doping level of PPy.

The morphologies of LiCoO₂/PPy:CMC cathode became rougher as the cycle number raised (FIG. 34). Good contact between electrode composite components sustained repeated cycling. The amorphous coverage layer of LiCoO₂ was probably a mixture of PPy:CMC composites and cathode electrolyte interface (CEI) product.

### Comparative Experiments for Determining Root Causes of Capacity Fading

The performance degradation of Li-ion battery cells could be attributed to many factors ranging from the intrinsic properties of electrode materials, to impurities in the electrolyte and other electrode components. It is worth noting that the magnitude of capacity fading was the same for both LiCoO₂/PVDF/C reference cathode and LiCoO₂/PPy:CMC cathode. The capacity fading mechanism might originate from the intrinsic degradation of LiCoO₂ in the investigated system. For example, some electrolyte additives were reported to suppress the degradation of LiCoO₂ in carbonate electrolytes. This study, however, used commercial 1 M LiPF₆ DMC:EC (50:50 v:v) electrolyte without electrolyte additives, which might contribute to the degradation observed. One possible cause for the degradation of LiCoO₂/PPy:CMC cathode could be impurities in liquid electrolytes used. However, as shown in EXAMPLE 2, the NMC111/PVDF/C cathode exhibited excellent capacity retention regardless of using the same bottle of LiFP₆-based liquid electrolyte. Therefore, electrolyte impurities would not be the reason for the capacity fading of these LiCoO₂ cathodes.

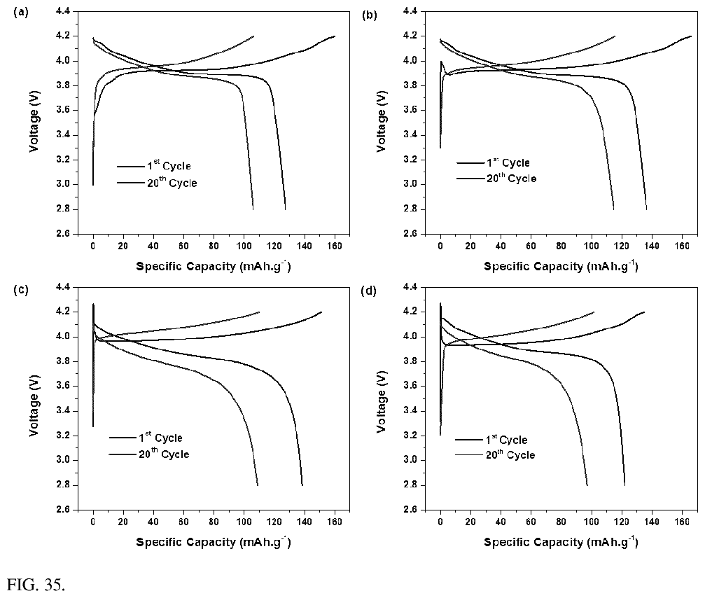

Residual chloride ions were reported in the composition of PPy:CMC composites that were previously purified by vacuum filtration. However, the chloride contamination would not affect electrochemical stability of PPy:CMC composites as explained in the cyclic voltammograms. The impact of residual chloride ions on the performance of LiCoO₂/PPy:CMC cathodes was not well-understood. In order to get rid of residual chloride ions in PPy:CMC composites, centrifugation was used to purify PPy:CMC composites. FIG. 35 (c) depicts the performance of LiCoO₂/PPy:CMC-centrifuged cathode, which was the same as that of normal LiCoO₂/PPy:CMC cathode, whose PPy:CMC composite was purified by vacuum filtration. Interestingly, the LiCoO₂/PPy:CMC-centrifuged cathode was not able to undergo charge/discharge processes when the normal battery cycling program was applied. It is confirmed that residual chloride ions acted as additional dopants for PPy in the structure of PPy:CMC composites. Upon removing residual chloride ions, the electrical conductivity of PPy:CMC composites was expected to decrease. As a result, the LiCoO₂/PPy:CMC-centrifuged cathode was not able to run when applying a fixed potential of 2.8 V to 4.2 V vs Li/Li⁺. However, by setting the charge potential limit to 4.5 V vs Li/Li⁺ in the first few minutes of the charging process, PPy:CMC composite was activated and the LiCoO₂/PPy:CMC-centrifuged cathode started to run as usual. As shown in FIG. 35 (c), the cell voltage of the LiCoO₂/PPy:CMC-centrifuged cathode went up to approximately 4.4 V vs Li/Li⁺ in seconds followed by decaying to around 4.0 V vs Li/Li⁺. This behavior further confirmed the hypothesis that PPy:CMC composite would undergo an activation process, where undoped PPy was doped by electrolyte anions.

As for LiPF₆ electrolyte, it is well-known that traces of moisture in electrode could react with LiPF₆, forming corrosive HF gas that attacks LiCoO₂ and degrades overall cell performance. Therefore, one could argue that the hygroscopic nature of the CMC component in PPy:CMC composite might lead to moisture absorption during the handling of LiCoO₂/PPy:CMC electrodes. To reject this hypothesis, several coin cells with LiCoO₂/PPy:CMC cathodes were made with 1M LiClO₄ in polypropylene carbonate electrolyte, which is insusceptible to moisture contamination. However, the electrode still suffered from capacity fading as shown in FIG. 35 (d).

To sum up, the degradation of the LiCoO₂/PPy:CMC cathode was likely due to the intrinsic problem of LiCoO₂ active materials. Nevertheless, more studies should have been done to fully understand the properties of CP-based electrode matrices such as PPy:CMC composites in the working environment of Li-ion batteries.

### Activating CP-Based Composites in the First Charging Process

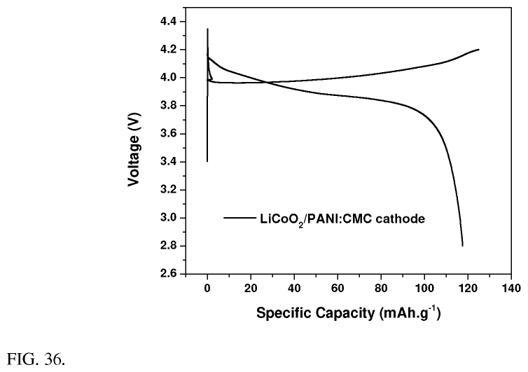

It is imperative to emphasize the importance of activating CPs in Li-ion batteries by setting a high charging potential limit in the first charging stage. This unique protocol of activating CPs in Li-ion batteries has not been reported elsewhere. Without activation, the electrical conductivity of CPs would be too low to conduct electrons in carbon-additive-free electrodes. As a result, most of the studies still added carbon additives to CP-containing electrodes. This intriguing activation phenomenon suggests a good strategy to activate CPs in Li-ion batteries. For example, PANI:CMC composite was able to function carbon-additive-free LiCoO₂/PANI:CMC cathode as depicted in FIG. 36. More information on the activation mechanism of CPs in Li-ion batteries would facilitate the adoption of CP-based electrode matrices for many types of rechargeable batteries.

### Conclusions

The study proved that PPy:CMC composite demonstrated good electrochemical stability within the potential range of cathode. Having a high number of carboxyl and hydroxyl groups, CMC offered a great affinity towards the surface of LiCoO₂, forming a good coverage on LiCoO₂ particles. During the first charging step, undoped PPy in PPy:CMC composite was oxidized to become fully-charged, which explained the abnormally sharp increase in the voltage profile within few seconds of the charging process. When the amount of residual chloride ions in PPy:CMC composites decreases by more careful purification, the activation potential was observed to increase accordingly. Once the activation potential goes beyond the upper working potential range of cathode (4.2 V vs Li/Li⁺ for LiCoO₂), setting a high potential limit (4.5 V vs Li/Li⁺ for LiCoO₂) in the first charging step is necessary to allow neutral PPy unit to be oxidized and doped, thus activating PPy:CMC composites. The same activation protocol has been applied successfully to activate PANI:CMC composites as electrode matrices. Based on the XPS measurement, as the cycle number increased, PF₆⁻ ions continued to substitute carboxyl groups and residual chloride ions to become one of the main dopants for positively charged PPy molecules. The degradation of LiCoO₂/PPy:CMC cathodes was likely to originate from the degradation of LiCoO₂.

While the preferred embodiments of the invention have been described above, it will be recognized and understood that various modifications may be made therein, and the appended claims are intended to cover all such modifications which may fall within the spirit and scope of the invention.

### REFERENCES

[1] R. J. Brodd, W. Huang, J. R. Akridge, Polymer battery R&D in the U.S., Macromol. Symp. 159 (2000) 229-246. https://doi.org/10.1002/1521-3900 (200010) 159:1<229::AID-MASY229>3.0.CO; 2-O.
[2] Y. Shi, X. Zhou, G. Yu, Material and Structural Design of Novel Binder Systems for High-Energy, High-Power Lithium-Ion Batteries, Acc. Chem. Res. 50 (2017) 2642-2652. https://doi.org/10.1021/acs.accounts.7b00402.
[3] J. Zhao, X. Yang, Y. Yao, Y. Gao, Y. Sui, B. Zou, H. Ehrenberg, G. Chen, F. Du, Moving to Aqueous Binder: A Valid Approach to Achieving High-Rate Capability and Long-Term Durability for Sodium-Ion Battery, Adv. Sci. 5 (2018) 1700768. https://doi.org/10.1002/advs.201700768.
[4] H. Chen, M. Ling, L. Hencz, H. Y. Ling, G. Li, Z. Lin, G. Liu, S. Zhang, Exploring Chemical, Mechanical, and Electrical Functionalities of Binders for Advanced Energy-Storage Devices, Chem. Rev. 118 (2018) 8936-8982. https://doi.org/10.1021/acs.chemrev.8b00241.
[5] D. L. Wood, J. D. Quass, J. Li, S. Ahmed, D. Ventola, C. Daniel, Technical and economic analysis of solvent-based lithium-ion electrode drying with water and NMP, Dry. Technol. 36 (2018) 234-244. https://doi.org/10.1080/07373937.2017.1319855.
[6] M. Dong, M. Hafezi, Z. Tong, L. Qin, Preparation and oil lubrication of polyvinylidene fluoride (PVDF) nanospheres, Mater. Res. Express. 6 (2019) 085093. https://doi.org/10.1088/2053-1591/ab220e.
[7] M. Wu, X. Xiao, N. Vukmirovic, S. Xun, P. K. Das, X. Song, P. Olalde-Velasco, D. Wang, A. Z. Weber, L. W. Wang, V. S. Battaglia, W. Yang, G. Liu, Toward an ideal polymer binder design for high-capacity battery anodes, J. Am. Chem. Soc. 135 (2013) 12048-12056. https://doi.org/10.1021/ja4054465.
[8] J. Hu, Y. Wang, D. Li, Y. T. Cheng, Effects of adhesion and cohesion on the electrochemical performance and durability of silicon composite electrodes, J. Power Sources. 397 (2018) 223-230. https://doi.org/10.1016/j.jpowsour.2018.06.103.
[9] J. M. Kim, H. S. Park, J. H. Park, T. H. Kim, H. K. Song, S. Y. Lee, Conducting polymer-skinned electroactive materials of lithium-ion batteries: Ready for monocomponent electrodes without additional binders and conductive agents, ACS Appl. Mater. Interfaces. 6 (2014) 12789-12797. https://doi.org/10.1021/am502736m.
[10] D. Bresser, D. Buchholz, A. Moretti, A. Varzi, S. Passerini, Alternative binders for sustainable electrochemical energy storage—the transition to aqueous electrode processing and bio-derived polymers, Energy Environ. Sci. 11 (2018) 3096-3127. https://doi.org/10.1039/C8EE00640G.
[11] C. R. Hernandez, A. Etiemble, T. Douillard, D. Mazouzi, Z. Karkar, E. Maire, D. Guyomard, B. Lestriez, L. Roue, A Facile and Very Effective Method to Enhance the Mechanical Strength and the Cyclability of Si-Based Electrodes for Li-Ion Batteries, Adv. Energy Mater. 8 (2018) 1-13. https://doi.org/10.1002/aenm.201701787.
[12] N. Loeffler, T. Kopel, G. T. Kim, S. Passerini, Polyurethane binder for aqueous processing of Li-ion battery electrodes, J. Electrochem. Soc. 162 (2015) A2692-A2698. https://doi.org/10.1149/2.0641514jes.
[13] J. Zhao, X. Yang, Y. Yao, Y. Gao, Y. Sui, B. Zou, H. Ehrenberg, G. Chen, F. Du, Moving to Aqueous Binder: A Valid Approach to Achieving High-Rate Capability and Long-Term Durability for Sodium-Ion Battery, Adv. Sci. 5 (2018) 1700768. https://doi.org/10.1002/advs.201700768.
[14] F. Bigoni, F. De Giorgio, F. Soavi, C. Arbizzani, Sodium Alginate: A Water-Processable Binder in High-Voltage Cathode Formulations, J. Electrochem. Soc. 164 (2017) A6171-A6177. https://doi.org/10.1149/2.0281701jes.
[15] J. Li, G. Zhang, Y. Yang, D. Yao, Z. Lei, S. Li, Y. Deng, C. Wang, Glycinamide modified polyacrylic acid as high-performance binder for silicon anodes in lithium-ion batteries, J. Power Sources. 406 (2018) 102-109. https://doi.org/10.1016/j.jpowsour.2018.10.057.
[16] Z. Zhang, T. Zeng, C. Qu, H. Lu, M. Jia, Y. Lai, J. Li, Cycle performance improvement of LifePO4 cathode with polyacrylic acid as binder, Electrochim. Acta. 80 (2012) 440-444. https://doi.org/10.1016/j.electacta.2012.07.054.
[17] A. Magasinski, B. Zdyrko, I. Kovalenko, B. Hertzberg, R. Burtovyy, C. F. Huebner, T. F. Fuller, I. Luzinov, G. Yushin, Toward efficient binders for Li-ion battery Si-based anodes: Polyacrylic acid, ACS Appl. Mater. Interfaces. 2 (2010) 3004-3010. https://doi.org/10.1021/am100871y.
[18] U. S. Vogl. P. K. Das, A. Z. Weber, M. Winter, R. Kostecki, S. F. Lux, Mechanism of interactions between CMC binder and si single crystal facets, Langmuir. 30 (2014) 10299-10307. https://doi.org/10.1021/la501791q.
[19] D. Mazouzi, R. Grissa, M. Paris, Z. Karkar, L. Huet, D. Guyomard, L. Roué, T. Devic, B. Lestriez, CMC-citric acid Cu (II) cross-linked binder approach to improve the electrochemical performance of Si-based electrodes, Electrochim. Acta. 304 (2019) 495-504. https://doi.org/10.1016/j.electacta.2019.03.026.
[20] Y. Shi, L. Peng, G. Yu, Nanostructured conducting polymer hydrogels for energy storage applications, Nanoscale. 7 (2015) 12796-12806. https://doi.org/10.1039/c5nr03403e.
[21] P. R. Das, L. Komsiyska, O. Osters, G. Wittstock, PEDOT:PSS as a Functional Binder for Cathodes in Lithium Ion Batteries, J. Electrochem. Soc. 162 (2015) A674-A678. https://doi.org/10.1149/2.0581504jes.
[22] K. Sun, S. Zhang, P. Li, Y. Xia, X. Zhang, D. Du, F. H. Isikgor, J. Ouyang, Review on application of PEDOTs and PEDOT:PSS in energy conversion and storage devices, J. Mater. Sci. Mater. Electron. 26 (2015) 4438-4462. https://doi.org/10.1007/s10854-015-2895-5.
[23] F. Wu, J. Liu, L. Li, X. Zhang, R. Luo, Y. Ye, R. Chen, Surface modification of Li-rich cathode materials for lithium-ion batteries with a PEDOT:PSS conducting polymer, ACS Appl. Mater. Interfaces. 8 (2016) 23095-23104. https://doi.org/10.1021/acsami.6b07431.
[24] K. Lee, S. Lim, A. Tron, J. Mun, Y. Kim, T. Yim, T.-H. Kim, Polymeric binder based on PAA and conductive PANI for high performance silicon-based anodes, RSC Adv. 6 (2016) 101622-101625. https://doi.org/10.1039/C6RA23805J.
[25] M. Zheng, C. Wang, Y. Xu, K. Li, D. Liu, A water-soluble binary conductive binder for Si anode lithium ion battery, Electrochim. (2019) 555-562. https://doi.org/10.1016/j.electacta.2019.02.080.
[26] M. Ling, J. Qiu, S. Li, C. Yan, M. J. Kiefel, G. Liu, S. Zhang, Multifunctional SA-PProDOT Binder for Lithium Ion Batteries, Nano Lett. 15 (2015) 4440-4447. https://doi.org/10.1021/acs.nanolett.5b00795.
[27] K. Dai, H. Zhao, Z. Wang, X. Song, V. Battaglia, G. Liu, Toward high specific capacity and high cycling stability of pure tin nanoparticles with conductive polymer binder for sodium ion batteries, J. Power Sources. 263 (2014) 276-279. https://doi.org/10.1016/j.jpowsour.2014.04.012.
[28] X. Li, H. An, J. Strzalka, J. Lutkenhaus, R. Verduzco, Self-doped conjugated polymeric binders improve the capacity and mechanical properties of V205 cathodes, Polymers. 11 (2019) 589. https://doi.org/10.3390/polym11040589.
[29] B. Liu, P. Soares, C. Checkles, Y. Zhao, G. Yu, Three-dimensional hierarchical ternary nanostructures for high-performance Li-ion battery anodes, Nano Lett. 13 (2013) 3414-3419. https://doi.org/10.1021/nl401880v.
[30] F. Zhao, J. Bae, X. Zhou, Y. Guo, G. Yu, Nanostructured Functional Hydrogels as an Emerging Platform for Advanced Energy Technologies, Adv. Mater. 30 (2018) 1-16. https://doi.org/10.1002/adma.201801796.
[31] Y. Guo, J. Bae, F. Zhao, G. Yu, Functional Hydrogels for Next-Generation Batteries and Supercapacitors, Trends Chem. 1 (2019) 335-348. https://doi.org/10.1016/j.trechm.2019.03.005.
[32] H. Wu, G. Yu, L. Pan, N. Liu, M. T. McDowell, Z. Bao, Y. Cui, Stable Li-ion battery anodes by in-situ polymerization of conducting hydrogel to conformally coat silicon nanoparticles, Nat. Commun. 4 (2013) 1943-1946. https://doi.org/10.1038/ncomms2941.
[33] J. Zheng, X. Yu, C. Wang, Z. Cao, H. Yang, D. Ma, X. Xu, Facile synthesis of three-dimensional reinforced Sn@polyaniline/sodium alginate nanofiber hydrogel network for high performance lithium-ion battery, J. Mater. Sci. Mater. Electron. 27 (2016) 4457-4464. https://doi.org/10.1007/s10854-016-4317-8.
[34] T. M. Higgins, S. H. Park, P. J. King, C. Zhang, N. McEvoy, N. C. Berner, D. Daly, A. Shmeliov, U. Khan, G. Duesberg, V. Nicolosi, J. N. Coleman, A Commercial Conducting Polymer as Both Binder and Conductive Additive for Silicon Nanoparticle-Based Lithium-Ion Battery Negative Electrodes, ACS Nano. 10 (2016) 3702-3713. https://doi.org/10.1021/acsnano.6b00218.
[35] X. Crispin, F. L. E. Jakobsson, A. Crispin, P. C. M. Grim, P. Andersson, A. Volodin, C. Van Haesendonck, M. Van Der Auweraer, W. R. Salaneck, M. Berggren, The origin of the high conductivity of poly(3,4-ethylenedioxythiophene)-poly(styrenesulfonate) (PEDOT-PSS) plastic electrodes, Chem. Mater. 18 (2006) 4354-4360. https://doi.org/10.1021/cm061032+.
[36] L. Qie, L. X. Yuan, W. X. Zhang, W. M. Chen, Y. H. Huang, Revisit of polypyrrole as cathode material for lithium-ion battery, J. Electrochem. Soc. 159 (2012) 1624-1629. https://doi.org/10.1149/2.042210jes.
[37] A. A. Pavlychev, K. H. Hallmeier, C. Hennig, L. Hennig, R. Szargan, Nitrogen K-shell excitations in complex molecules and polypyrrole, Chem. Phys. 201 (1995) 547-555. https://doi.org/10.1016/0301-0104 (95) 00287-1.
[38] C. Sasso, E. Zeno, M. Petit-Conil, D. Chaussy, M. N. Belgacem, S. Tapin-Lingua, D. Beneventi, Highly conducting polypyrrole/cellulose nanocomposite films with enhanced mechanical properties, Macromol. Mater. Eng. 295 (2010) 934-941. https://doi.org/10.1002/mame.201000148.
[39] W. E. S. Unger, A. Lippitz, C. Wöll, W. Heckmann, X-ray absorption spectroscopy (NEXAFS) of polymer surfaces, Fresenius. J. Anal. Chem. 358 (1997) 89-92. https://doi.org/10.1007/s002160050352.
[40] C. Karunakaran, C. R. Christensen, C. Gaillard, R. Lahlali, L. M. Blair, V. Perumal, S. S. Miller, A. P. Hitchcock, Introduction of soft x-ray spectromicroscopy as an advanced technique for plant biopolymers research, PLOS One. 10 (2015) 1-18. https://doi.org/10.1371/journal.pone.0122959.
[41] G. D. Cody, J. Brandes, C. Jacobsen, S. Wirick, Soft X-ray induced chemical modification of polysaccharides in vascular plant cell walls, J. Electron Spectros. Relat. Phenomena. 170 (2009) 57-64. https://doi.org/10.1016/j.elspec.2008.09.007.
[42] A. Azioune, F. Siroti, J. Tanguy, M. Jouini, M. M. Chehimi, B. Miksa, S. Slomkowski, Interactions and conformational changes of human serum albumin at the surface of electrochemically synthesized thin polypyrrole films, Electrochim. Acta. 50 (2005) 1661-1667. https://doi.org/10.1016/j.electacta.2004.10.014.
[43] F. Zhang, J. Dou, H. Zhang, Mixed Membranes Comprising Carboxymethyl Cellulose (as Capping Agent and Gas Barrier Matrix) and Nanoporous ZIF-L Nanosheets for Gas Separation Applications, Polymers. 10 (2018) 1340. https://doi.org/10.3390/polym10121340.
[44] F. T. A. Vork, B. C. A. M. Schuermans, E. Barendrecht, Influence of inserted anions on the properties of polypyrrole, Electrochim. Acta. 35 (1990) 567-575. https://doi.org/10.1016/0013-4686 (90) 87045-4.
[45] S. J. Davies, T. G. Ryan, C. J. Wilde, G. Beyer, Processable forms of conductive polyaniline, Synth. Met. 69 (1995) 209-210. https://doi.org/10.1016/0379-6779 (94) 02418-X.
[46] R. E. D. La Rue, C. W. Tobias, On the Conductivity of Dispersions, J. Electrochem. Soc. 106 (1959) 827. https://doi.org/10.1149/1.2427505.
[47] I. V. Thorat, D. E. Stephenson, N. A. Zacharias, K. Zaghib, J. N. Harb, D. R. Wheeler, Quantifying tortuosity in porous Li-ion battery materials, J. Power Sources. 188 (2009) 592-600. https://doi.org/10.1016/j.jpowsour.2008.12.032.
[48] A. S. Hutchison, T. W. Lewis, S. E. Moulton, G. M. Spinks, G. G. Wallace, Development of polypyrrole-based electromechanical actuators, Synth. Met. 113 (2000) 121-127. https://doi.org/10.1016/S0379-6779 (00) 00190-9.
[49] P. Murray, G. M. Spinks, G. G. Wallace, R. P. Burford, Electrochemical induced ductile-brittle transition in tosylate-doped (pTS) polypyrrole, Synth. Met. 97 (1998) 117-121. https://doi.org/10.1016/s0379-6779 (98) 00119-2.
[50] G. Bidan, B. Ehui, M. Lapkowski, Conductive polymers with immobilised dopants: Ionomer composites and auto-doped polymers—a review and recent advances, J. Phys. D. Appl. Phys. 21 (1988) 1043-1054. https://doi.org/10.1088/0022-3727/21/7/001.
[51] N. V. Blinova, J. Stejskal, M. Trchová, J. Prokeš, M. Omastová, Polyaniline and polypyrrole: A comparative study of the preparation, Eur. Polym. J. 43 (2007) 2331-2341. https://doi.org/10.1016/j.eurpolymj.2007.03.045.
[52] Y. Xu, Y. Zhang, Synthesis of polypyrrole/sodium carboxymethyl cellulose nanospheres with enhanced supercapacitor performance, Mater. Lett. 139 (2015) 145-148. https://doi.org/10.1016/j.matlet.2014.10.074.
[53] C. Sasso, D. Beneventi, E. Zeno, D. Chaussy, M. Petit-Conil, P. Nortier, N. Belgacem, Polypyrrole synthesis via carboxymethylcellulose-iron complexes, BioResources. 5 (2010) 2348-2361. https://doi.org/10.15376/biores.5.4.2348-2361.
[54] V. A. Nguyen, C. Kuss, Review-Conducting Polymer-Based Binders for Lithium-Ion Batteries and Beyond, J. Electrochem. Soc. 167 (2020) 065501. https://doi.org/10.1149/1945-7111/ab856b.
[55] J. Yang, Y. Liu, S. Liu, L. Li, C. Zhang, T. Liu, Conducting polymer composites: Material synthesis and applications in electrochemical capacitive energy storage, Mater. Chem. Front. 1 (2017) 251-268. https://doi.org/10.1039/c6qm00150e.
[56] X. Jiang, Y. Sha, R. Cai, Z. Shao, The solid-state chelation synthesis of LiNi1/3Co1/3Mn1/3O2 as a cathode material for lithium-ion batteries, J. Mater. Chem. A. 3 (2015) 10536-10544. https://doi.org/10.1039/C5TA01236H.
[57] A. Altomare, N. Corriero, C. Cuocci, A. Falcicchio, A. Moliterni, R. Rizzi, QUALX2.0: a qualitative phase analysis software using the freely available database POW_COD, J. Appl. Crystallogr. 48 (2015) 598-603. https://doi.org/10.1107/S1600576715002319.
[58] S.-C. Yin, Y.-H. Rho, I. Swainson, L. F. Nazar, X-ray/Neutron Diffraction and Electrochemical Studies of Lithium De/Re-Intercalation in Li1−xCo1/3Ni1/3Mn1/3O2 (x=0→1), Chem. Mater. 18 (2006) 1901-1910. https://doi.org/10.1021/cm0511769.
[59] V. A. Nguyen, J. Wang, C. Kuss, Conducting polymer composites as water-dispersible electrode matrices for Li-Ion batteries: Synthesis and characterization, J. Power Sources Adv. 6 (2020) 100033. https://doi.org/10.1016/j.powera.2020.100033.
[60] G. Zhang, B. Qiu, Y. Xia, X. Wang, Q. Gu, Y. Jiang, Z. He, Z. Liu, Double-helix-superstructure aqueous binder to boost excellent electrochemical performance in Li-rich layered oxide cathode, J. Power Sources. 420 (2019) 29-37. https://doi.org/10.1016/j.jpowsour.2019.02.086.
[61] T. Zhang, J. Li, J. Liu, Y. Deng, Z. Wu, Z. Yin, D. Guo, L. Huang, S. Sun, Suppressing the voltage-fading of layered lithium-rich cathode materials via an aqueous binder for Li-ion batteries, Chem. Commun. 52 (2016) 4683-4686. https://doi.org/10.1039/C5CC10534J.
[62] T. Ohzuku, A. Ueda, Solid-State Redox Reactions of LiCoO₂ (R3m) for 4 Volt Secondary Lithium Cells, J. Electrochem. Soc. 141 (1994) 2972-2977. https://doi.org/10.1149/1.2059267.
[63] J. N. Reimers, J. R. Dahn, Electrochemical and In Situ X-Ray Diffraction Studies of Lithium Intercalation in LixCoO2, J. Electrochem. Soc. 139 (1992) 2091-2097. https://doi.org/10.1149/1.2221184.
[64] T. Kawamura, T. Sonoda, S. Okada, J. Yamaki, Improvement of the Stability of LiPF₆ Electrolytes toward Water by the Addition of LiCl, Electrochemistry. 71 (2003) 1139-1141. https://doi.org/10.5796/electrochemistry.71.1139.
[65] L. Lin, F. Liang, K. Zhang, H. Mao, J. Yang, Y. Qian, Lithium phosphide/lithium chloride coating on lithium for advanced lithium metal anode, J. Mater. Chem. A. 6 (2018) 15859-15867. https://doi.org/10.1039/c8ta05102j.
[66] L. Dahéron, H. Martinez, R. Dedryvère, I. Baraille, M. Ménétrier, C. Denage, C. Delmas, D. Gonbeau, Surface Properties of LiCoO₂ Investigated by XPS Analyses and Theoretical Calculations, J. Phys. Chem. C. 113 (2009) 5843-5852. https://doi.org/10.1021/jp803266w.

1. An electrode matrix comprising:
an electrically conductive polymer; and
a polyanionic binder.

2. The electrode matrix according to claim 1 wherein the electronically conductive polymer is selected from the group consisting of: polyacetylene, polyphenylene sulphide, polyphenylene vinylene, polyisothianaphthene, polythiophene, poly(3-alkylthiophene), poly(3,4-ethylenedioxythiophene), polyaniline and polypyrrole.

3. The electrode matrix according to claim 1 wherein the electronically conductive polymer is selected from the group consisting of: polythiophene, poly(3-alkylthiophene), poly(3,4-ethylenedioxythiophene), polyaniline and polypyrrole.

4. The electrode matrix according to claim 1 wherein the electronically conductive polymer is polyaniline or polypyrrole.

5. The electrode matrix according to claim 1 wherein the polyanionic binder is selected from the group consisting of: polystyrene sulfonate, sodium carboxymethyl cellulose, sodium polyacrylate, and sodium alginate.

6. The electrode matrix according to claim 1 wherein the polyanionic binder is selected from the group consisting of: sodium carboxymethyl cellulose, sodium polyacrylate, and sodium alginate.

7. (canceled)

8. The electrode matrix according to claim 1 wherein the electrically conductive polymer and the polyanionic binder are present at 5-95% electrically conductive polymer and 5-95% polyanionic binder.

9. (canceled)

10. A method of activating an electrode matrix comprising:
mixing an electrically conductive polymer, a polyanionic binder and an oxidant;
fabricating an electrode matrix from the mixture of the electrically conductive polymer, the polyanionic binder and the oxidant; and
subjecting the electrode matrix to a charging voltage at or above a typical upper cut off voltage for the electrode matrix until at least an expected electrode capacity is reached.

11. The method according to claim 10 wherein the charging voltage is above the typical cut off voltage for at least a first 10% of charging.

12. The method according to claim 10 wherein the electrode matrix is subjected to the charging voltage above the typical cut off voltage and then subjected to a standard first charge cycle.

13. The method according to claim 10 wherein the charging voltage is held at the upper cut off voltage at the end of a first charge until theoretical electrode capacity is reached.

14. The method according to claim 10 wherein the electrode matrix is subjected first to a minimum amount of charge at the typical upper cut off voltage and then subjected to a charging voltage above the typical cut off voltage for the electrode matrix until theoretical electrode capacity is reached.

15. The method according to claim 10 wherein the electronically conductive polymer is selected from the group consisting of: polyacetylene, polyphenylene sulphide, polyphenylene vinylene, polyisothianaphthene, polythiophene, poly(3-alkylthiophene), poly(3,4-ethylenedioxythiophene), polyaniline and polypyrrole.

16. The method according to claim 10 wherein the electronically conductive polymer is selected from the group consisting of: polythiophene, poly(3-alkylthiophene), poly(3,4-ethylenedioxythiophene), polyaniline and polypyrrole.

17. The method according to claim 10 wherein the electronically conductive polymer is polyaniline or polypyrrole.

18. The method according to claim 10 wherein the polyanionic binder is selected from the group consisting of: polystyrene sulfonate, sodium carboxymethyl cellulose, sodium polyacrylate, and sodium alginate.

19. The method according to claim 10 wherein the polyanionic binder is selected from the group consisting of: sodium carboxymethyl cellulose, sodium polyacrylate, and sodium alginate.

20. (canceled)

21. The method according to claim 10 wherein the electrically conductive polymer and the polyanionic binder are mixed at 5-95% electrically conductive polymer and 5-95% polyanionic binder.

22. (canceled)

23. The method according to claim 10 wherein the oxidant is selected from the group consisting of: chromic acid, perchloride acid, hydrogen peroxide, dibenzoyl peroxide, ammonium perchlorate, ferric chloride and ammonium persulfate.

24. The method according to claim 10 wherein the oxidant is selected from the group consisting of: ammonium perchlorate, ferric chloride and ammonium persulfate.

25. The method according to claim 10 wherein the oxidant is ferric chloride or ammonium persulfate.
